(19) United States
(12) Patent Application Publication
(10) Pub. No.: US 2017/0289277 A1
(43) Pub. Date: Oct. 5, 2017

(54) METHOD AND DEVICE FOR PERFORMING WIRELESS DOCKING SERVICE

(71) Applicant: LG ELECTRONICS INC., Seoul (KR)

(72) Inventors: Jaeho LEE, Seoul (KR); Dongcheol KIM, Seoul (KR); Byungjoo LEE, Seoul (KR); Jangwoong PARK, Seoul (KR)

(73) Assignee: LG ELECTRONICS INC., Seoul (KR)

(21) Appl. No.: 15/504,973

(22) PCT Filed: Apr. 28, 2015
(86) PCT No.: PCT/KR2015/004254

§ 371 Date: Feb. 17, 2017

Related U.S. Application Data
(60) Provisional application No. 62/039,386, filed on Aug. 19, 2014.

(51) Int. Cl. H04L 29/08; H04L 29/10; H04W 84/18; H04W 76/02; H04W 4/00; H04W 88/04

(52) U.S. Cl. CPC H04L 67/16; H04W 4/008; H04W 88/04; H04W 84/18; H04W 76/023; H04L 29/10; H04L 29/08

(57) ABSTRACT

Disclosed herein is a method for performing, by a wireless dockee center (WDC), a docking service in a docking system. The method includes performing a docking connection procedure with a wireless dockee (WD), establishing a WSB (Wi-Fi serial bus) connection with the wireless dockee, and communicating with a Bluetooth host of the wireless dockee using a host controller interface (HCI), wherein the Bluetooth host of the wireless dockee is connected to a Bluetooth controller of the wireless dockee center through the HCI.

### TECHNICAL FIELD

The present invention relates to a docking system and, more particularly, to a wireless docking system in a home network environment.

### BACKGROUND ART

Related art docking systems for playing (or reproducing) music or images of personal portable devices such as smartphones, or the like, using an external speaker, or the like, are operated by physically connecting the portable devices to a docking center and manipulating a user interface (UI) of the docking center.

Here, for the docking connection, the portable devices should be physically connected, causing users to be limited in using the systems, and due to the limited environment of the physical connection, user application coverage is extremely limited to music play or speaker phones.

In order to solve such a limit, recently in Wi-Fi alliance, a standardization job for a wireless docking system using a Wi-Fi interface is in progress, but there are still a lot of environment limits in using a heterogeneous wireless communication such as Bluetooth.

### DISCLOSURE

### Technical Problem

Hence, an object of the present specification is to provide convenience in technical aspects and compatibility with the existing technologies so that Bluetooth interface may be utilized in Wi-Fi docking system.

Further, another object of the present specification is to provide a wireless docking system capable of performing a docking service without a physical connection between devices.

Further, another object of the present specification is to provide a docking protocol for user environment extension in a wireless docking system.

Further, another object of the present specification is to provide a method of tunneling a peripheral device with a dockee using Bluetooth HCI information when using Bluetooth technology when the interface between the peripheral device and the docking center uses Bluetooth technology.

Further, another object of the present specification is to provide a synchronization procedure of a controller and a Bluetooth host between a dockee and a docking center.

Further, another object of the present specification is to provide a Bluetooth HCI tunneling method by a service matching and a service (or profile) discovery procedure.

Technical objects to be achieved by the present invention are not limited to the aforementioned objects, and those skilled in the art to which the present invention pertains may evidently understand other technical objects from the following description.

### Technical Solution

In an aspect of the present invention, a method for performing, by a wireless dockee center (WDC), a docking service in a docking system includes performing a docking connection procedure with a wireless dockee (WD), establishing a WSB (Wi-Fi serial bus) connection with the wireless dockee, and communicating with a Bluetooth host of the wireless dockee using a host controller interface (HCI), wherein the Bluetooth host of the wireless dockee is connected to a Bluetooth controller of the wireless dockee center through the HCI.

The method may further include blocking HCI of, the Bluetooth controller and a Bluetooth host of the wireless dockee center, for Bluetooth HCI connection with the Bluetooth host of the wireless dockee and transmitting HCI information of the Bluetooth controller of the wireless dockee center to the wireless dockee.

The method may further include performing a Bluetooth pairing procedure with a peripheral device and storing Bluetooth service information of the peripheral device obtained through the Bluetooth pairing procedure.

The method may further include performing a Bluetooth service discovery procedure with the wireless dockee.

The Bluetooth service discovery procedure may include transmitting the stored Bluetooth service information of the peripheral device to the wireless dockee.

The stored Bluetooth service information of the peripheral device may be transmitted through a Wi-Fi ASP (application service platform) response message, a GENA (general event notification architecture) event notification message or a UPnP (universal plug & play) response message.

The performing of the docking connection may include receiving a service information provided from the Bluetooth host of the wireless dockee from the wireless dockee and storing the received service information provided from the Bluetooth host of the wireless dockee.

The service information provided from the Bluetooth host of the wireless dockee may be received from the wireless dockee through Wi-Fi ASP or UPnP action.

The method may further include performing a Bluetooth service discovery procedure with the peripheral device and performing a Bluetooth pairing procedure with the peripheral device.

The Bluetooth service discovery procedure may include receiving a Bluetooth service discovery message from the peripheral device and transmitting the stored Bluetooth service information of the wireless dockee to the peripheral device.

The method may further include setting a new Bluetooth L2CAP (logical link control and adaptation) between the wireless dockee and the peripheral device after establishing the WSB connection.

The setting of the new L2CAP channel may include receiving from the wireless dockee, a control message requesting a reattempt of the Bluetooth pairing procedure between the wireless dockee center and the peripheral device.

The setting of the new Bluetooth L2CAP channel may further include transmitting a response to the control message to the wireless dockee, wherein the response includes a Bluetooth L2CAP channel ID (identifier) which has already been formed with the peripheral device.

The method may further include performing a disconnection of the Bluetooth L2CAP channel which has already been formed with the peripheral device.

The control message may be a Bluetooth setup UPnP action.

In another aspect of the present invention, a method for performing, by a wireless dockee (WD), a docking service in a docking system, includes performing a docking connection procedure with a wireless dockee center (WDC), establishing a WSB (Wi-Fi serial bus) connection with the wireless dockee center, and communicating with a Bluetooth controller of the wireless dockee center using a host controller interface (HCI), wherein the Bluetooth controller of the wireless dockee center is connected to a Bluetooth host of the wireless dockee through the HCI.

The method may further include receiving HCI (host controller interface) information of the Bluetooth controller of the wireless dockee center, from the wireless dockee center and performing a Bluetooth service discovery procedure with the wireless dockee center, wherein the Bluetooth service discovery procedure includes receiving Bluetooth service information of a peripheral device, which is stored in the wireless dockee center, from the wireless dockee center, matching a service of the Bluetooth host of the wireless dockee with the received service of the peripheral device, and determining whether to use the peripheral device according to a certain criterion as a result of the matching.

The certain criterion may be a case that there is at least one matched service, a case that the service of the wireless dockee is entirely included in the service of the peripheral device, or a case that there is no matched service.

As a result of the matching, if there is the at least one matched service or the service of the wireless dockee is entirely included in the service of the peripheral device, a Bluetooth HCI tunneling may be performed with the peripheral device.

In another aspect of the present invention, a wireless dockee (WD) apparatus for performing a docking service in a docking system includes a communication unit for communicating with an external side in a wireless or wired manner and a controller functionally connected to the communication unit, wherein the controller is configured to perform a docking connection procedure with a wireless dockee center (WDC), establish a WSB (Wi-Fi serial bus) connection with the wireless dockee center, and communicate with a Bluetooth controller of the wireless dockee center using a HCI (host controller interface), and wherein the Bluetooth controller of the wireless dockee center is connected to a Bluetooth host of the wireless dockee through the HCI.

### Advantageous Effects

Hence, according to the present specification, the user convenience can be maximized by utilizing display devices such as a monitor and various input/output devices such as a keyboard, a mouse, and a printer in using a miniaturized personal portable device.

Further, according to the present specification, since there is no physical connection between a device forming such an environment for user convenience and a personal portable device, there is no physical environment restriction in the docking service operation and the extension of the applicable use-case is very easy.

Further, according to the present specification, the peripheral device, which has been connected to the docking center through a dockee, may be remotely controlled or used by using HCI information, Wi-Fi serial bus and Bluetooth technology which is the communication standard between the Bluetooth host and the Bluetooth controller.

Further, according to the present specification, the simplicity in the device implementation may be provided by drawing a clear solution capable of performing communication by integrating communication technologies between different types.

Advantages which may be obtained by the present invention are not limited to the aforementioned advantages, and various other advantages may be evidently understood by those skilled in the art to which the present invention pertains from the following description.

### DESCRIPTION OF DRAWINGS

FIG. 1 illustrates a wireless docking system to which the methods proposed in the present specification are applicable.

FIG. 2a illustrates an example of an internal block diagram of a dockee to which the methods proposed in the present specification are applicable.

FIG. 2b illustrates an example of an internal block diagram of a docking center and a peripheral device to which the methods proposed in the present specification are applicable.

FIG. 2c illustrates another example of an internal block diagram of a dockee and a docking center to which the methods proposed in the present specification are applicable.

FIG. 3 schematically illustrates an internal configuration of a dockee and a docking center in aspect of function to which the methods proposed in the present specification are applicable.

FIG. 4a is a flowchart illustrating an example of a MAC layer docking discovery procedure to which the methods proposed in the present specification are applicable.

FIG. 4b illustrates a service discovery procedure in a Wi-Fi direct network.

FIG. 4c is a flowchart illustrating a method for performing a docking discovery using a service discovery in a Wi-Fi direct network.

FIG. 4d is a flowchart illustrating another example of a MAC layer docking discovery procedure for performing a docking service using Wi-Fi.

FIG. 5a is a flowchart illustrating an example of an application docking discovery procedure.

FIG. 5b is a flowchart illustrating another example of an application docking discovery procedure.

FIG. 6a is a flowchart illustrating an example of a docking paring procedure in a wireless docking system.

FIG. 6b is a flowchart illustrating another example of a docking pairing procedure in a wireless docking system.

FIG. 7a is a flowchart illustrating an example of a docking operation procedure in an event-driven scheme.

FIG. 7b is a flowchart illustrating an example of a docking operation procedure in a periodic scheme in a wireless docking system.

FIG. 7c is a flowchart illustrating an example of a docking operation procedure in which an event-driven scheme and a periodic scheme are used together in a wireless docking system which uses Wi-Fi.

FIG. 7d is a flowchart illustrating an example of a docking operation procedure by a user command in a wireless docking system which uses Wi-Fi.

FIG. 8a is a flowchart illustrating an example of a docking termination procedure by a user request.

FIG. 8b is a flowchart illustrating an example of a docking termination procedure by a time-out.

FIG. 9a is a flowchart illustrating an example of a communication procedure with a docking center and a docking-dedicated peripheral device.

FIG. 9b is a flowchart illustrating another example of a communication procedure with a docking center and a docking-dedicated peripheral device.

FIG. 10 illustrates an example of a user interface related to a docking discovery procedure.

FIG. 11 illustrates an example of a user interface related to a docking pairing procedure.

FIG. 12 illustrates an example that a wireless docking system which uses Wi-Fi is utilized at home or in an office.

FIG. 13 illustrates an example that a wireless docking system which uses Wi-Fi is utilized in a public place.

FIG. 14 illustrates another example that a wireless docking system which uses Wi-Fi is utilized.

FIG. 15 illustrates a situation that a dockee directly controls a docking center without using a peripheral device in a wireless docking system which uses Wi-Fi.

FIG. 16 illustrates an example of a method of tunneling Bluetooth HCI information between a dockee and a docking center which are proposed in the present specification.

FIG. 17 is a flowchart illustrating an example of a synchronization procedure between a dockee and a docking center which are proposed in the present specification.

FIG. 18 is a flowchart illustrating an example of a Bluetooth HCU tunneling method proposed in the present specification.

FIGS. 19 to 21 are flowcharts illustrating examples of a method of using a peripheral device through a Bluetooth HCI tunneling proposed in the present specification.

### MODE FOR INVENTION

Hereinafter, embodiments of the present disclosure will be described in detail with reference to the accompanying drawings.

In the following description, usage of suffixes such as ‘module’, ‘part’ or ‘unit’ used for referring to elements is given merely to facilitate explanation of the present invention, and the ‘module’ and ‘part’ or ‘unit’ may be mixedly used.

A device described in the present disclosure is a device available for wireless communication, which may include a cellular phone including a smartphone, a tablet PC, a desktop computer, a notebook computer, or a television including a smart TV or an IPTV.

Also, embodiments of the present disclosure will be described in detail with reference to the accompanying drawings and contents described in the accompanying drawings hereinafter, but the present disclosure is not limited thereto.

The terms used in this specification were selected to include current, widely-used, general terms, in consideration of the functions of the present invention. However, the terms may represent different meanings according to the intentions of the skilled person in the art or according to customary usage, the appearance of new technology, etc.

In certain cases, a term may be one that was arbitrarily established by the applicant. In such cases, the meaning of the term will be defined in the relevant portion of the detailed description.

As such, the terms used in the specification are not to be defined simply by the name of the terms but are to be defined based on the meanings of the terms as well as the overall description of the present invention.

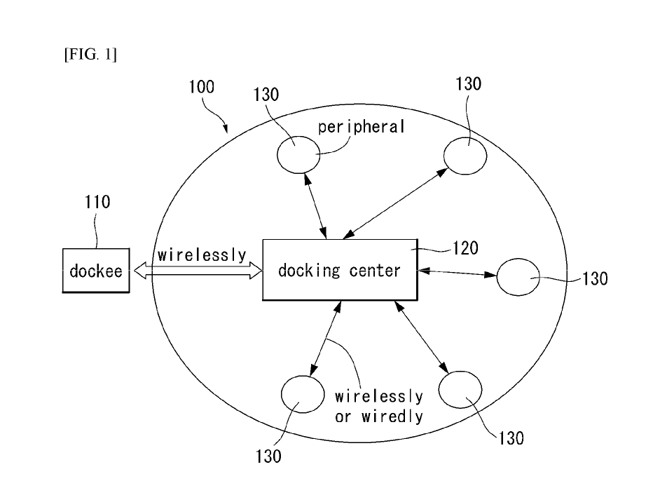

FIG. 1 is a view illustrating an example of a wireless docking system proposed in the present disclosure.

The wireless docking system may also be expressed as a Wi-Fi docking system.

As illustrated in FIG. 1, the wireless docking system 100 includes a dockee 110, a docking center 120, and a peripheral 130. The dockee 110, the docking center 120, and the peripheral 130 are main components constituting the wireless docking system 100, and here, the wireless docking system 100 may further include any other component.

First, the dockee 110, a target device for utilizing the wireless docking system 100, may be a smartphone, a laptop computer, a tablet PC, a portable player (e.g., an MP3, or the like), a portable game console, and a camera.

The dockee 110 may also be expressed as a wireless dockee (WD) or a Wi-Fi dockee, and may be connected to the docking center 120 to select a series of peripheral devices for docking with the dockee 110.

The docking center 120 may be wiredly or wirelessly connected with various peripherals.

The docking center 120 refers to a device for controlling the dockee 110, that is, a target device to which the dockee 120 is to be paired. Also, the docking center 120 may have a display function according to circumstances. The docking center 120 may be a monitor, a TV, a tablet PC, separate network equipment. The separate network equipment refers to an access point (AP), a router, or a gateway.

The peripheral 130 refers to a peripheral device such as an input/output device or a convenience device that may be directly used by a user, which is a hardware component performing at least one peripheral function (PF).

The peripheral 130 may be a home automation device such as a mouse, a keyboard, a game pad, a speaker/microphone, a projector/display, car equipment, a printer/scanner, or lighting.

When the dockee 110 docks to the docking center 120, a Wi-Fi peripheral such as a WSB or a Wi-Fi display may be directly connected to the dockee 110 or may be connected to the dockee 110 in a relay manner through the docking center 120.

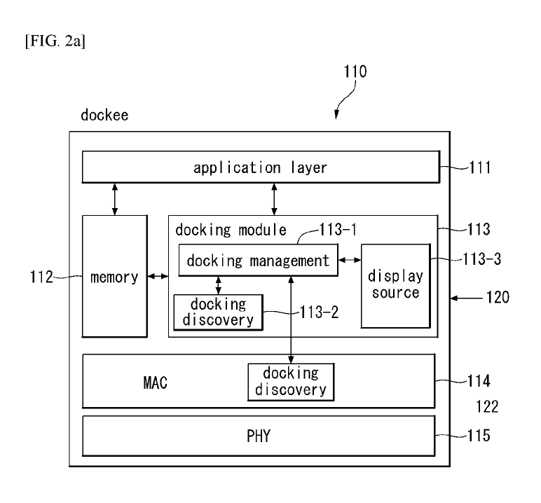

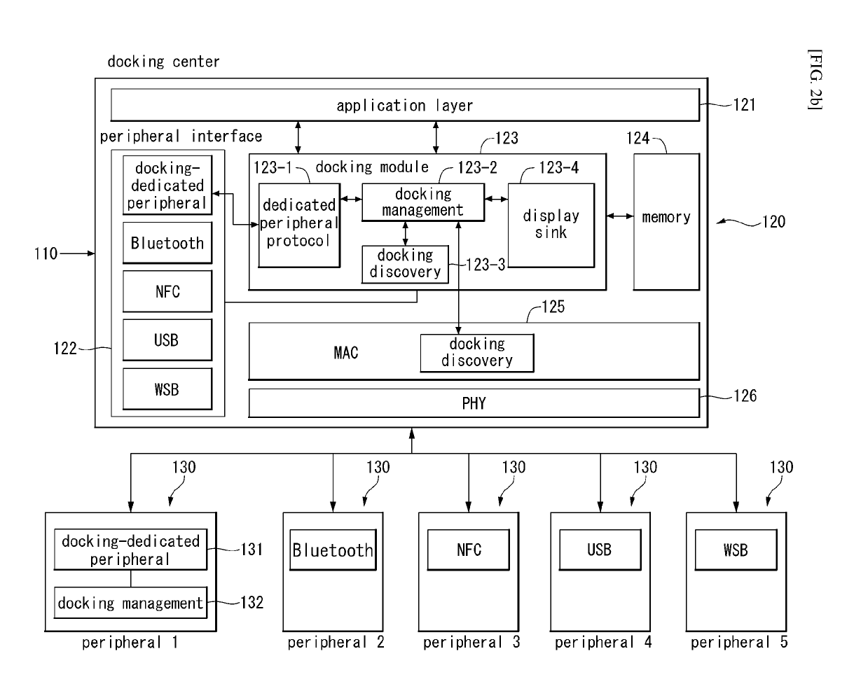

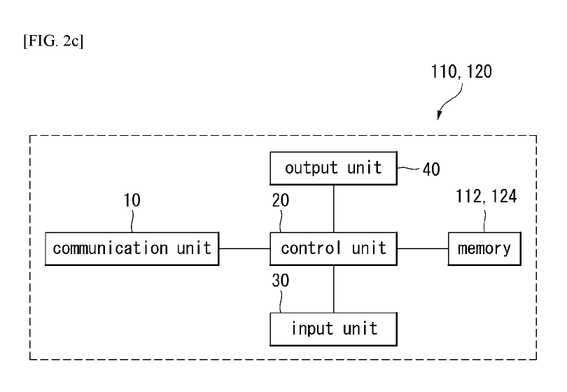

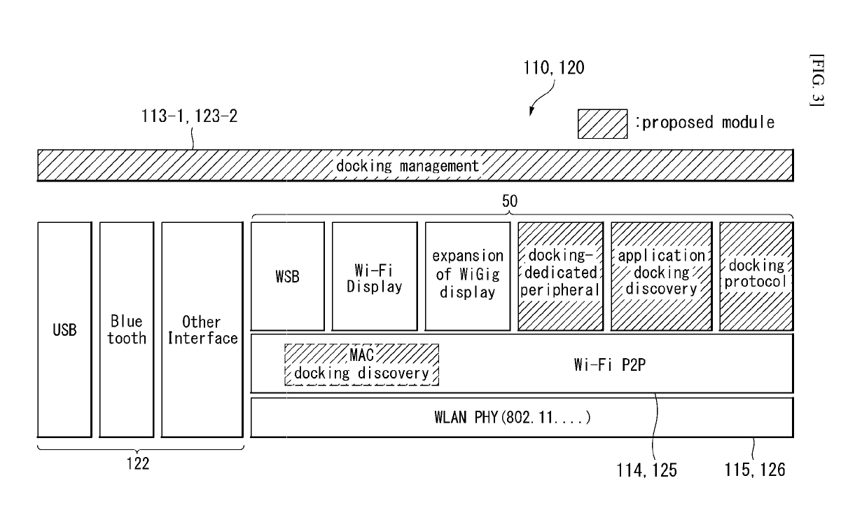

FIGS. 2A and 2B are views illustrating examples of internal blocks of the dockee 110, the docking center 120, and the peripheral 130 proposed in the present disclosure.

The dockee 110 illustrated in FIG. 2A and the docking center 120 and the peripheral 130 illustrated in FIG. 2B may be connected wiredly or wirelessly.

First, the dockee 110 includes an application layer 111, a memory 112, a docking module 113, a wireless medium access control (MAC) layer 114, and a wireless physical (PHY) layer 115.

The docking module 113 includes a docking management module 113-1, a docking discovery module 113-2, and a display source 113-3.

The docking center 120 includes an application layer 121, a peripheral interface 122, a docking module 123, a memory 124, a wireless MAC layer 125, and a wireless physical layer 126.

The peripheral interface 122 may be configured as an interface of a docking dedicated peripheral, Bluetooth, near-field communication (NFC), universal serial bus (USB), or a Wi-Fi serial bus (WSB).

The docking module 123 includes a protocol for a dedicated peripheral (or a dedicated peripheral protocol) 123-1, a docking management module 123-2, a docking discovery module 123-3, and a display sink 123-4.

The wireless MAC layers of the dockee 110 and the docking center 120 include a docking discovery module.

The dockee 110 and the docking center 120 are wirelessly connected through Wi-Fi.

The peripheral 130 is connected to the docking center 120 wiredly or wirelessly. Referring to FIGS. 2A and 2B, the docking center 110 is connected to five peripherals 130.

A peripheral 1, a docking dedicated peripheral, includes a docking dedicated peripheral function module 131 and a docking management module 132

A peripheral 2 is a peripheral available for Bluetooth communication, a peripheral 3 is a peripheral available for NFC communication, a peripheral 4 is a peripheral available for USB communication, and a peripheral 5 is a Wi-Fi serial bus (WSB) available for Wi-Fi communication.

A MAC protocol and a PHY protocol of the dockee 110 and the docking center 120 will be described in detail.

First, when a request for transmission of data is received from a MAC protocol, the PHY protocol serves to perform forward error correction (FEC) encoding, modulation, and insertion of an additional signal such as a preamble or pilot, on the requested data, and transmit the same to a communication unit.

Also, when a signal transmitted from a transceiver unit is received, the PHY protocol serves to perform demodulation, equalization, FEC decoding, and configuration of the signal added in the PHY protocol on the reception signal, and transmit data according to the MAC protocol.

In order to perform the foregoing function, the PHY protocol may include a modulator, a demodulator, an equalizer, an FEC encoder, and an FEC decoder.

In order to deliver or transmit data delivered from a higher layer to the PHY protocol, the MAC protocol may perform a required process, and is responsible for an additional transmission to perform basic communication.

To this end, the MAC protocol serves to process the data requested to be transmitted by the higher layer into a form that can be appropriate for transmission, and deliver and transmit the same to the PHY protocol, and also serves to process reception data delivered from the PHY protocol and deliver the same to a higher layer.

Also, the MAC protocol is responsible for any other additional transmission and reception required for data delivery, thereby processing a communication protocol.

FIG. 2C is a view illustrating another example of an internal block diagram of the dockee and the docking center proposed in the present disclosure.

As illustrated in FIG. 2C, the dockee 110 and the docking center 120 include a communication unit (or a transceiver unit) 10, a control unit 20, an input unit 30, an output unit 40, and a memory 112 or 124.

The communication unit 10, the control unit 20, the input unit 30, the output unit 40, and the memory 112 or 124 are functionally connected to perform the method proposed in the present disclosure.

When information generated by the PHY protocol is received, the communication unit (transceiver unit or a radio frequency (RF) unit) 10 moves the received information to an RF spectrum, performs filtering and amplification on the received information, and transmits the same to an antenna. Also, the communication unit 10 serves to move an RF signal received by the antenna to a band that can be processed by the PHY protocol, and perform filtering thereon.

The communication unit 10 may have a switch function for switching the transmission and reception functions.

The control unit 20 implements the function, process, and/or method proposed in the present disclosure. Layers of the wireless interface protocol may be implemented by the control unit 20.

That is, in order to perform a wireless docking service for Wi-Fi, the control unit 20 may control docking discovery, a docking operation, docking pairing, and a docking closing operation.

Also, the control unit 20 controls the communication unit 10 to transmit a probe request including a docking information element 1 for discovering a wireless docking center (WDC) supporting the docking service, controls the communication unit 10 to receive a probe response including a docking information element 2 from the WDC which has received the probe request and perform docking connection with the docking center on the basis of the received probe response.

Also, the control unit 20 controls the communication to receive a docking request (Docking_Request) for docking connection from the dockee (wireless dockee (WD)) 110, controls the communication unit to transmit detailed information request for requesting detailed information of a peripheral to the peripheral, receive detailed information as a response to the detailed information request from the peripheral, and transmit a docking response (Docking_Response) as a response to the docking request to the dockee 110.

The memory 112 or 124 is connected to the control unit 20 and stores a protocol or a parameter for performing a wireless docking service using Wi-Fi.

The control unit 20 may include an application-specific integrated circuit (ASIC), other chip set, a logic circuit, and/or a data processing device. The memory 112 or 124 may include a read-only memory (ROM), a random access memory (RAM), a flash memory, a memory card, a storage medium and/or any other storage device. The communication unit 10 may include a baseband circuit for processing a wireless signal. When an embodiment is implemented by software, the foregoing scheme may be implemented by the modules (processes, functions, and the like) performing the foregoing functions. The modules may be stored in the memory and may be executed by the control unit 20. The memory 112 or 124 may be disposed within or outside of the control unit 20 and may be connected to the control unit 20 through various well-known units.

The output unit (or display unit) 40 is controlled by the control unit 20, and output information items output from the control unit 20, together with a key input signal generated by a key input unit (not shown) and various information signals from the control unit 20.

FIG. 3 is a view schematically illustrating an internal configuration of the dockee and the docking center proposed in the present disclosure in a functional aspect.

As illustrated in FIG. 3, the docking management modules 113-1 and 123-2 manage and control connection to a target device, access and usage history, and device information in the dockee and the docking center.

A docking protocol is a protocol for controlling, monitoring, and information exchanging between the dockee and the docking center.

A docking discovery module performs a discovery (search or finding) function to search neighboring devices for a device providing a wireless docking system.

Here, there are a MAC docking discovery performed in the MAC layer and an application docking discovery performed in an application layer.

The MAC docking discovery functions to search whether docking is supported before establishing an IP-based association in a data link layer.

The application docking discovery functions to search whether a docking is supported in an application layer when the MAC docking discovery function cannot be used.

A dedicated peripheral protocol does not support a commercial interface such as a USB or Bluetooth and serves to support only a wireless docking system.

Docking Discovery

Hereinafter, a docking discovery procedure for performing a docking service proposed in the present disclosure will be described.

The docking discovery includes a MAC layer docking discovery procedure and an application layer docking discovery procedure.

First, the MAC layer docking discovery procedure will be described.

A MAC responsible for a data link layer in Wi-Fi wireless communication performs a probing or beacon procedure, an authentication procedure, and an association procedure before an L2 connection establishment.

The foregoing procedures may need to perform channel scanning, or the like, according to circumstances, so a large amount of time may be taken.

A communication protocol of every application layer is started after completion of the MAC connection establishment procedure, and the discovery procedure for wireless docking cannot be performed until the MAC connection procedure is completed, even though a docking target device is located within a communication available distance.

Due to performing of the data link procedure, docking discovery in the application layer require a relatively longer period of time to perform. Also, as the number of neighbor devices increases, the time for performing the docking discovery procedure is increased proportionally.

Information items transmitted and received between the dockee, the docking center, and the peripherals described hereinafter may be transmitted and received in the form of a message, a frame, signaling, or a primitive.

MAC Layer Docking Discovery

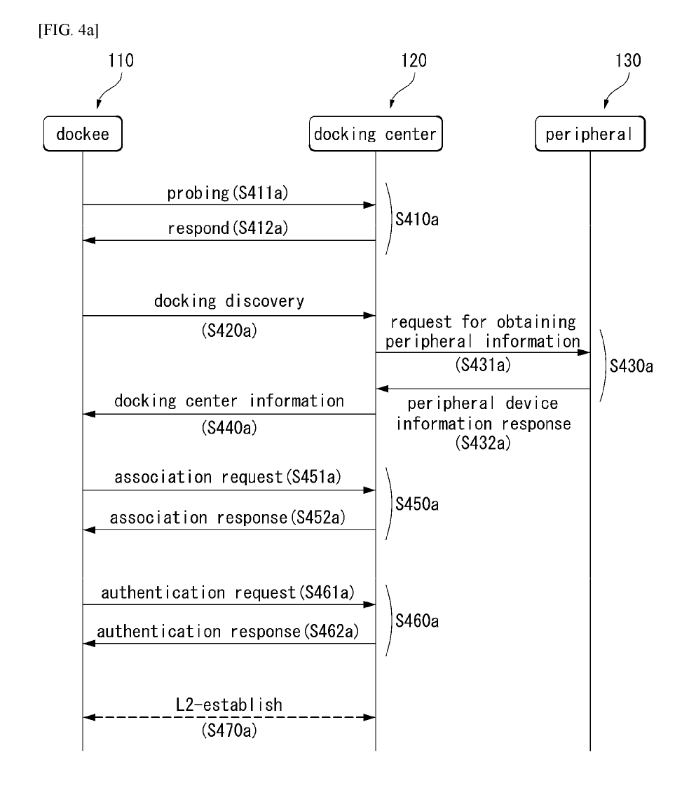

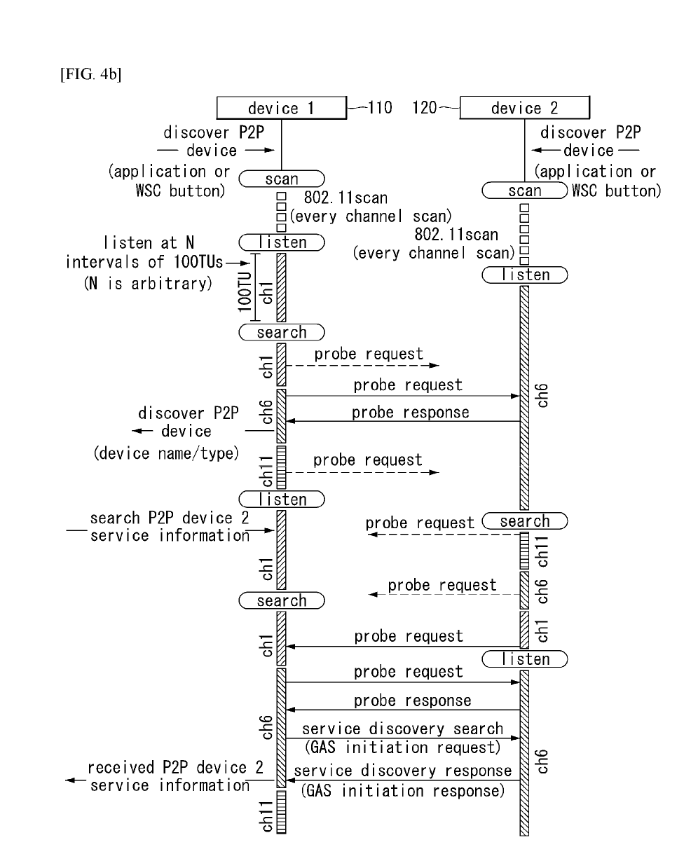

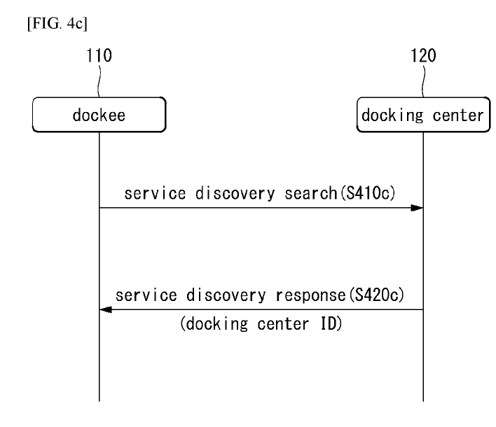

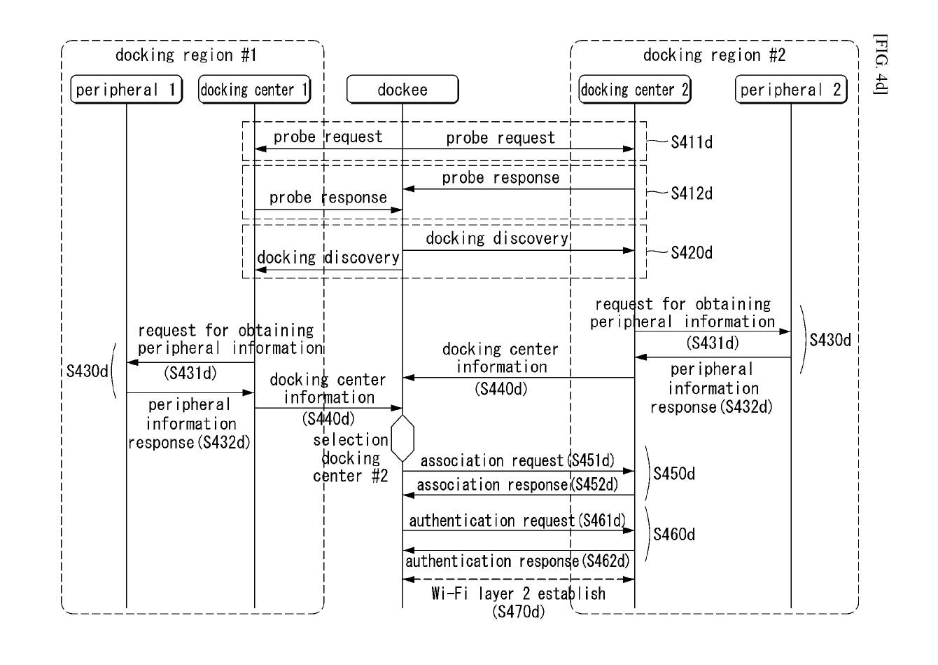

FIG. 4A is a flow chart illustrating an example of a MAC layer docking discovery procedure proposed in the present disclosure.

First, in order to search for a docking center present nearby (adjacency, proximity, surrounding), the dockee transmits probing or a probe request (S411a).

Thereafter, upon receiving the probing, the docking center transmits a response with respect to the probing, that is, a probe response, to the dockee (S412a).

Thereafter, in order to recognize whether a docking service is supported, the dockee broadcasts a docking discovery to the docking center (S420).

The docking discovery (message) includes information of Table 1 below.

TABLE 1
<Docking Discovery>

| | | Selective | |
|---|---|---|---|
| Parameter | Type | Value | Description |
| Dockee_ID | Unsigned Int | None | Dockee ID |
| | | | value |

In Table 1, a dockee identifier (Dockee_ID) parameter denotes an ID for identifying a dockee.

Thereafter, the docking center transmits a peripheral information request (Get_Peripheral_Info) to a peripheral which can be connected to the docking center, which is dependent thereon, or which can be controlled to request information thereof (S431a).

The peripheral information request message includes information of Table 2 below.

TABLE 2
<Get_Peripheral_Info>

| | | Selective | |
|---|---|---|---|
| Parameter | Type | Value | Description |
| Docking_Center_ID | Unsigned Int | None | Docking |
| | | | Center ID |
| | | | value |

In Table 2, the Docking_Center_ID parameter denotes an ID for identifying a docking center.

Thereafter, upon receiving the peripheral information request from the docking center, the peripheral transmits peripheral information response including detailed information thereof to the docking center (S432b).

The peripheral information message includes information such as shown in Table 3 below.

TABLE 3
<Peripheral_Info>

| | | Selective | |
|---|---|---|---|
| Parameter | Type | Value | Description |
| Docking_Center_ID | Unsigned Int | None | Docking |
| | | | Center ID |
| | | | value |
| Peripheral_List | Structure Array | None | Information |
| | (Peripheral_Sum- | | of Peripheral |
| | mary_t) | | list |
| | | | (See Table 4) |

In Table 3, the Peripheral_List parameter denotes information of peripheral list, and details may be referred to Table 4.

TABLE 4
<Peripheral_Summary_t>

| | | Selective | |
|---|---|---|---|
| Parameter | Type | Value | Description |
| Peripheral_ID | Unsigned Int | None | Docking |
| | | | Center ID |
| | | | value |
| Dev_name | String | None | Device Name |
| Peripheral_Type | Enum | Mouse | Usable Device |
| | | Keyboard | Type |
| | | Printer/Scanner | [symbol] |
| | | Display | |
| | | Home Automation | |

In Table 4, the Peripheral_Type parameter denotes a type of an available peripheral, and may denote a mouse, a keyboard, a printer/scanner, a display, and home automation according to a set value.

Thereafter, the docking center transmits docking center information (Docking_Center_Info) including information of the docking center to the dockee (S440a).

The docking center information includes information items illustrated in Table 5 below.

TABLE 5
<Docking_Center_Info>

| | | Selective | |
|---|---|---|---|
| Parameter | Type | Value | Description |
| Dockee_ID | Unsigned Int | None | Dockee ID |
| | | | value |
| Docking_Center_ID | Unsigned Int | None | Docking |
| | | | Center ID |
| | | | value |
| Dev_name | String | None | Device Name |
| Num_Connect- | Unsigned Int | None | Number of |
| ed_Dockee | | | connected |
| | | | Dockee |
| | | | (Number of |
| | | | dockees |
| | | | connected |
| | | | to docking |
| | | | Center) |
| Num_Peripheral | Unsigned Int | None | Number of |
| | | | supportable |
| | | | Peripheral |
| | | | (Number of |
| | | | peripherals |
| | | | connected |
| | | | to docking |
| | | | Center) |
| Peripheral_List | Structure Array | None | Summary of |
| | (Peripheral_Sum- | | Peripheral |
| | mary_t) | | list (summary |
| | | | information |
| | | | of available |
| | | | peripherals) |

In Table 5, the docking center ID parameter denotes an ID for identifying a docking center, the Dev name parameter denotes a name of a device, and the Num Connected Dockee parameter denotes the number of dockees currently connected to the docking center.

Also, the Numn Peripheral parameter denotes the number of peripherals connected to the docking center, the Peripheral List parameter denotes the number of peripherals connected to the docking center, and the Peripheral List parameter denotes available peripherals and summary information thereof, details thereof may be referred to Peripheral Summary of Table 4.

Thereafter, the dockee recognizes whether the docking service is supported on the basis of the docking center information received from the docking center, and performs an association process with the docking center (S450a).

Here, during the association process, the dockee transmits an association request (Association Req) to the docking center (S451a), and the docking center transmits an association response (Association Rsp) as a response to the association request, to the dockee (S452a).

When the association procedure between the dockee and the docking center is completed, the dockee and the docking center performs an authentication procedure (S460a).

During the authentication procedure, the dockee transmits an authentication request (Authentication Req) to the docking center (S461a), and the docking center transmits an authentication response, as a response to the authentication request, to the dockee (S462a).

When the authentication procedure between the dockee and the docking center is completed, a Layer-2 connection is established between the dockee and the docking center (S470a).

Hereinafter, a MAC layer docking discovery procedure for performing the docking service using Wi-Fi will be described.

First, in a Wi-Fi direct network (system or environment), a MAC layer discovery procedure is performed using a service discovery procedure.

FIG. 4B is a view illustrating a service discovery procedure in a Wi-Fi direct network.

The Wi-Fi direct network (or system) includes at least one Wi-Fi device. Here, the Wi-Fi device refers to a device able to perform Wi-Fi communication, and the Wi-Fi direct network may be expressed as a peer-to-peer (P2P) network.

Wi-Fi devices within the Wi-Fi direct network may be directly connected to each other without using a wireless location area network (WLAN) access point (AP). To this end, the Wi-Fi devices implement a new firmware protocol.

A P2P discovery procedure allowing P2P devices (or Wi-Fi devices) to rapidly discover each other and to be connected to each other in the Wi-Fi direct network will be described with reference to FIG. 4B.

The P2P discovery procedure may be classified as 1) a device discovery procedure and 2) a service discovery procedure.

The devices within the Wi-Fi direct network perform the device discovery process for recognizing each other before being connected through the Wi-Fi direct network.

The devices within the Wi-Fi direct network perform the service discovery process to exchange predetermined information with a device searched through the device discovery process to thereby know service information provided by the searched device.

Device Discovery

A purpose of the P2P device discovery is to search for P2P devices and determine a P2P device to which connection is to be attempted. The P2P device discovery includes two main steps, that is, a scan phase and a find phase.

In the device discovery process, in order to exchange device information a probe request frame and a probe response frame are used. P2P devices of a P2P group are discovered through a probe response frame from a P2P group owner (GO).

The P2P device do not response to the probe request frame unless it is 1) a P2P group owner, 2) it is in a listen state, or 3) it is not a P2P device connected to an infrastructure AP in a channel through which the probe request has been sent.

Hereinafter, the listen state, the scan phase, and the fine phase will be described in detail.

Listen State

A P2P device not included in the P2P group may use the listen state in order to be discovered.

In the listen state, the P2P device is present in a given channel of a listen channel. The listen channel is a channel selected from a list of social channels. In 2.4 GHz, channel 1, channel 6, and channel 11 will be used as social channels.

The listen channel will be selected at a start stage of the device discovery and remain the same until the P2P discovery is completed.

The find phase creates the use of the listen state. In the fine phase, the P2P device may stay in the listen state during a time period defined in the find phase, and may be constantly used during the corresponding time period.

When not in the fine phase, the P2P device may stay in the listen state during an extended time period. The P2P device may use the listen state during a continuous period of 500 ms of at least every 5 seconds to enable other devices to discover the P2P device.

Scan Phase

The scan phase may be used to search for P2P devices or a P2P group by the P2P device or position the best latent operation channel to establish a P2P group.

In the scan phase, information regarding nearby devices or network is collected by scanning all the channels supported for devices.

In the scan phase, the P2P device will not respond to a probe request frame.

The P2P device may scan P2P groups and legacy networks (for example, 802.11 infrastructure networks) simultaneously.

Find Phase

The find phase is use to guarantee that two P2P devices simultaneously performing searching reach a common channel allowing for communication.

This part may be formed as the P2P device circulates between a state in which the P2P device waits in a fixed channel during a probe request frame (that is, a listen state) or a state in which a probe request frame is sent in a fixed channel list (that is, a search state).

Convergence of two devices in the same channel is assisted by randomizing a time consumed in each cycle of the listen state. A convergence time is minimized by limiting a channel list to a small set known as a social channel.

In the fine phase, the P2P device will be exchanged between the listen state and the search state.

A duration time of each listen state in the find phase will be a certain integer at an interval of 100 TU. The certain number will not be greater than a maximum discoverable interval value and will not be smaller than a minimum discoverable interval value.

A determined value of the maximum discoverable interval and a determined value of the minimum discoverable interval are 3 and 1, respectively. Randomization in the time consumed in the listen state allows for avoiding a situation in which two P2P devices cannot find out each other in a lock step of the find phase.

While in the listen state of the find phase, the P2P device will be constantly used in a listen channel.

Service Discovery

Hereinafter, the service discovery procedure will be described in more detail.

As a service discovery response frame, a generic advertisement service (GAS) initial response frame defined in IEEE P802.11u is used.

Since the service discovery response frame supports different search types, vender-specific content may include other fields. A service exchange ID is included in both service request and service response type length values (TLVs) and is used to be matched to a response with respect to a request.

When a service discovery query frame is used for both services and higher layer service protocol types, a service discovery response frame may include a plurality of service response TLVs.

Each of the service response TLVs will include a service protocol type (for example, Bonjour, UPnP, etc.) set as one of values not ‘0’ defined in a service protocol type.

The service exchange ID is set to a value corresponding to a service exchange ID in a service request TLV. A state code field of each returned service TLV is set to service availability. Available service information is included in a response data field.

The response data field will include service data present in a service information type and a service protocol type. If any service is not available to be used, one service response TLV is returned as a ‘null’ value in a service protocol type field the same as ‘0’ and a state code field and a response data field set by an appropriate error code.

When the service discovery query frame includes a plurality of service request TLVs for a plurality of higher layer services and one or more service protocol types, the service discovery response frame will include a plurality of service response TLVs.

At least one service response TLV will be returned as each of corresponding service request TLVs by the service exchange ID. Each of the service response TLVs will include a service type field set to one of values not ‘0’ defined in a table corresponding to a requested service protocol type. The service exchange ID is set to a value corresponding to a service exchange ID in the service request TLV.

If a service is available to be used, the state code field is set to service availability and a response data field includes a corresponding requested service information type and service data.

If a service is not available to be used, the state code field is set to an appropriate error state value and a response data field has a ‘null’ value.

A service update indicator will be included in all of service discovery response frames. The service update indicator will be increased whenever service information of a P2P device which sends the service update indicator in a service discovery response is changed.

The service update indicator permits the P2P device to store service information obtained from another P2P device together with the service update indicator.

Whenever the P2P device recognizes that the service update indicator for the different P2P device increases, it may know that stored service information is sent for the corresponding P2P device.

If a service discovery response frame having a plurality of service response TLVs exceeds a GAS initial response packet size, the rule for GAS segments using a GAS comeback request and response will be used as being defined in IEEE P802.11u.

To sum up, the service discovery process uses the service discovery request frame and the service discovery response frame, for exchange of service information provided by each device.

The service discovery request frame and the service discovery response frame are generated by using a generic advertisement service (GAS) initial request frame and GAS initial response frame of IEEE 802.11u, respectively.

Each device may obtain information of a service provided from a counterpart of the service discovery through the service discovery process.

FIG. 4C is a flow chart illustrating a method for performing docking discovery using a service discovery in a Wi-Fi direct network proposed in the present disclosure.

As illustrated in FIG. 4C, in order to determine whether the docking center supports a docking service, the dockee transmits a service discovery request (SD_Query) frame including a Wi-Fi docking (or docking discovery) service protocol type field to the docking center (S410c).

Thereafter, the docking center transmits a service discovery response (SD_Discovery) frame including a docking center ID to the dockee, as a response with respect to the service discovery request frame (S420c).

A process required for performing the docking discovery procedure, excluding steps S410c and S420c, will be referred to FIG. 4B.

Table 6 below illustrates an example of the service discovery request frame TLV fields.

TABLE 6
<Service Request TLV Fields>

| Field Name | Size(octets) | Value | Description |
|---|---|---|---|
| Length | 2 | Variable | Length of the Service |
| | | | Request TLV |
| Service Protocol | 1 | Table 63 | Service protocol types |
| Type | | | |
| Service Transaction | 1 | Variable | Service transaction ID |
| ID | | | is a nonzero value used |
| | | | to match the Service |
| | | | Request/Response |
| | | | TLVs. |
| Query Data | Variable | NA | Query data for the |
| | | | requested service |
| | | | information |

In Table 6, the Length field denotes a length of the service request frame TLV, the Service Protocol Type field denotes a service protocol type supported by a device, and specific types of each service protocol type are illustrated in Table 7. The Service Transaction ID is a value not ‘0’ used for matching TLVs of a service request frame and a service response frame. The Query Data denotes request data of requested service information.

Table 7 below illustrates an example of the Service Protocol Type of Table 6.

TABLE 7
<Service Protocol Types>

| Value | Meaning |
|---|---|
| 0 | All Service Protocol Types |
| 1 | Bonjour |
| 2 | UPnP |
| 3 | WS-Discovery |
| 4 | Wi-Fi Display |
| 5-254 | Reserved (Wi-Fi Docking added, Docking Discovery) |
| 255 | |

In Table 7, a service protocol type value related to a Wi-Fi docking service may be set to any one of 5 to 254 values. For example, when the service protocol type value is set to ‘5’, it indicates that a service discovery request frame is transmitted to determined whether a Wi-Fi docking (docking discovery) is supported.

In another embodiment, in a Wi-Fi infrastructure, a MAC layer docking discovery procedure is performed by adding ‘docking’ to an advertisement protocol within a beacon.

However, the MAC layer docking discovery procedure in the Wi-Fi infrastructure is limited to a case of using an AP supporting IEEE 802.11u (GAS).

In a case in which an AP supporting IEEE 802.11u (GAS) is not used, an application layer docking discovery procedure is performed.

Table 8 below illustrates an example of a beacon frame body including ‘docking’ in an advertisement protocol.

TABLE 8
<Beacon frame body>

| Order | Information | Notes |
|---|---|---|
| 31 | Multiple | One or more Multiple BSSID elements are |
| | BSSID | present if dot11RRMMeasurementPilotCapability |
| | | is a value between 2 and 7 and the AP is a |
| | | member of a Multiple BSSID Set(see 11.10.11) |
| | | with two or more members, or if |
| | | dot11MgmtOptionMultiBSSIDEnabled is true, |
| | | or if dot11InterworkingServiceEnabled is true |
| | | and the AP is a member of a Multiple BSSID |
| | | Set with two or more members and the value of |
| | | at least one dot11GASAdvertisementID is not |
| | | null |
| 45 | Interworking | The Interworking element is present if |
| | | dot11InterworkingServiceEnabled is true |
| 46 | Advertisement | Advertisement Protocol element is present if |
| | Protocol | dot11InterworkingServiceEnabled is true and |
| | | the value of at least one |
| | | dot11GASAdvertisementID is not null |
| 47 | Roaming | The Roaming Consortium element is present if |
| | Consortium | dot11InterworkingServiceEnabled is true and |
| | | the dot11RoamingConsortiumTable has at least |
| | | one not-null entry |
| 48 | Emergency | One or more Emergency Alert Identifier |
| | Alert | elements are present if dot11EASEnabled is |
| | Identifier | true and there are one or more EAS message(s) |
| | | active in the network |

FIG. 4D is a flow chart illustrating another example of a MAC layer docking discovery procedure for performing a docking service using Wi-Fi proposed in the present disclosure.

In FIG. 4D, it is assumed that two docking regions (docking region #1 and docking region #2) are present and the dockee docks to one of two docking regions.

In the docking region #1, a docking center 1 and a peripheral 1 dependent on (or subordinate to) the docking center 1 are present, and in the docking region #2, a docking center 2 and a peripheral 2 dependent on the docking center 2.

As illustrated in FIG. 4D, in order to search for a docking center present around the dockee, the dockee broadcasts a probe request to the docking center 1 and the docking center 2 (S411d).

Thereafter, upon receiving the probe request from the dockee, the docking center 1 and the docking center 2 transmit a response with respect to the probe request, namely, a probe response, to the dockee (S412d).

Thereafter, in order to recognize whether a docking service is supported, the dockee broadcasts docking discovery to the docking center 1 and the docking center 2 (S420d).

Thereafter, the docking center 1 and the docking center 2 transmit a peripheral information request (Get_Peripheral_Info) to the peripheral 1 and the peripheral 2 which can be connected thereto or which is dependent thereon in order to request information of the peripheral, respectively (S431d).

Thereafter, the peripheral 1 which has received the peripheral information request from the docking center 1 and the peripheral 2 which has received the peripheral information request from the docking center 2 transmit peripheral information response including detailed information thereof to the docking center 1 and the docking center 2, respectively (S432d).

Thereafter, the docking center 1 and the docking center 2 each transmit docking center information including information thereof to the dockee (S440d).

Thereafter, on the basis of the docking center information received from the docking center 1 and the docking center 2, the dockee selects a docking center to perform a docking service. In FIG. 4D, it can be seen that the docking center 2 is selected.

Thereafter, the dockee performs an association procedure with the docking center 2 (S450d).

The process of performing the association procedure and an authentication procedure with the docking center 2 is the same as steps S450a and S460a of FIG. 4A, and thus, a detailed description thereof will be omitted.

When step S460d is completed, a Wi-Fi layer 2 connection is established between the dockee and the docking center 2 (S470d).

Application Layer Docking Discovery

Hereinafter, an application layer docking discovery process will be described.

Wireless communication schemes used by the dockee and the docking center include various types of techniques, and in a case, the docking discovery function of the data link layer may not be performed according to a specific MAC technique.

In such a case, in the present disclosure, a docking discovery procedure, rather than the MAC docking discovery procedure, is performed.

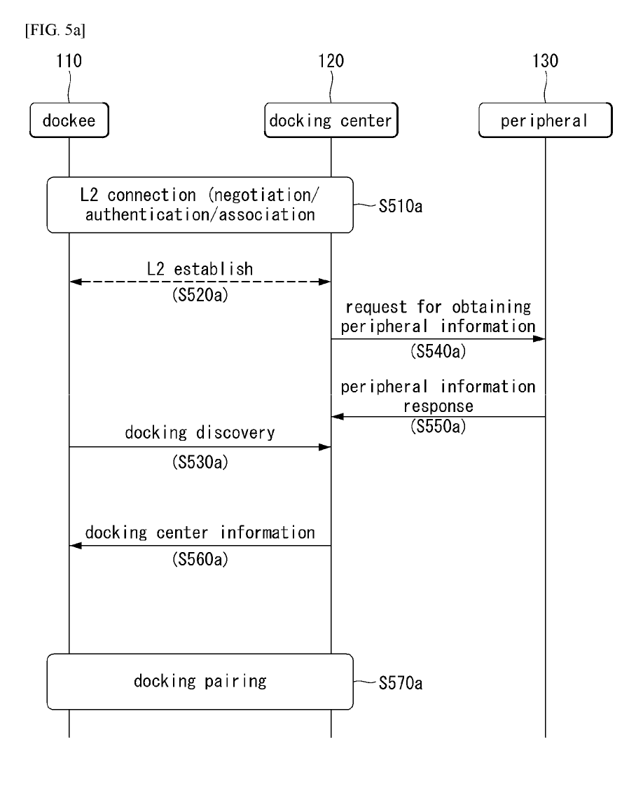

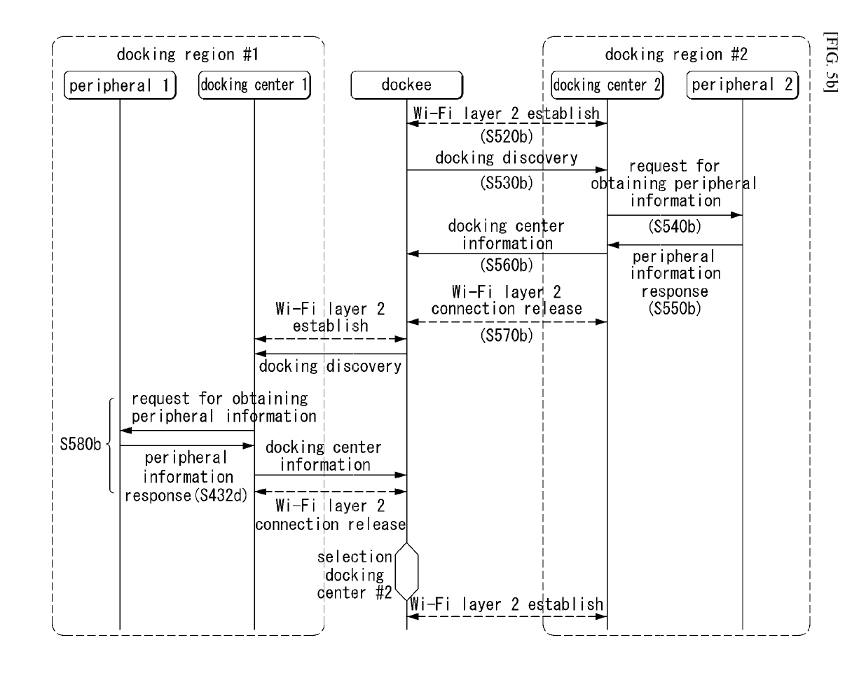

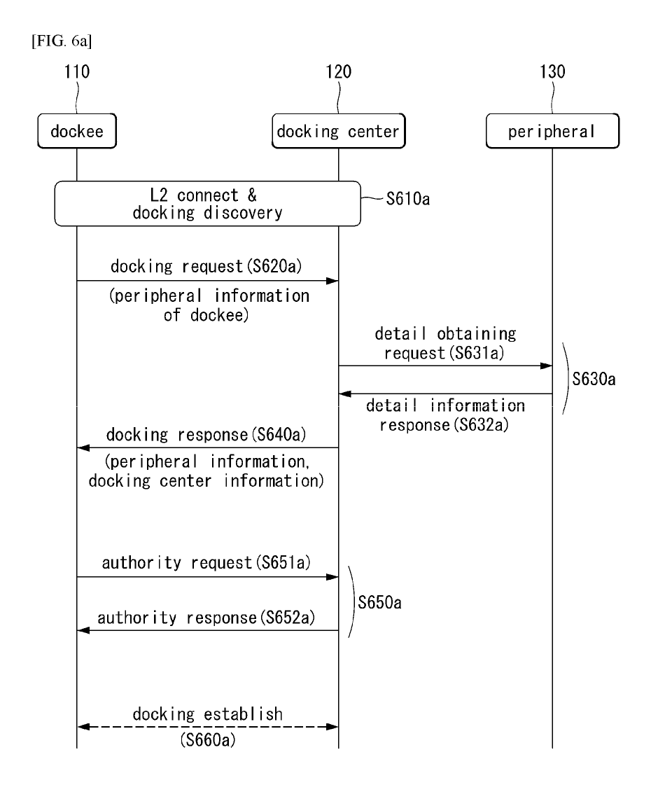

FIG. 5A is a flow chart illustrating an example of an application layer docking discovery procedure proposed in the present disclosure.

Docking discovery in the application layer is performed after a procedure for establishing a connection between data link layers of the dockee and the docking center.

As illustrated in FIG. 5A, the dockee and the docking center performs a negotiation procedure, an authentication procedure, and an association procedure for an L2 connection to thereby establish a Layer 2 connection between the dockee and the docking center (S520a).

Thereafter, in order to recognize whether a docking service is supported, the dockee transmits docking discovery to the Layer 2 connection-established docking center (S530a).

Here, the procedure for transmitting the docking discovery differs in an infrastructure environment and a direct-connection environment.

That is, in the infrastructure environment, the dockee transmits the docking discovery in a broadcast manner to every device available for direct communication with the dockee, and receives a response with respect to the docking discovery in a unicast manner to recognize information of a nearby docking center.

However, in the direct-connection environment, the dockee recognizes docking center information after performing all of connection establishment of the data link layer with every device available for connection.

Thereafter, the docking center transmits a peripheral information obtainment request to a peripheral dependent on the docking center (S540a).

Thereafter, the peripheral which has received the peripheral information obtainment request form the docking center transmits a peripheral information response including detailed peripheral information thereof, as a response thereto, to the docking center (S550a).

Thereafter, the docking center transmits the docking center information to the dockee (S560a).

Thereafter, the dockee and the docking center perform a docking pairing procedure (S570a).

FIG. 5B is a flow chart illustrating another example of an application layer docking discovery procedure proposed in the present disclosure.

In FIG. 5B, it is illustrated that two docking regions (docking region #1 and docking region #2) are present and the dockee performs docking on one of two docking regions.

In the docking region #1, a docking center 1 and a peripheral 1 dependent on the docking center 1 are present, and in the docking region #2, a docking center 2 and a peripheral 2 dependent on the docking center 2.

First, the dockee establishes a Layer 2 connection with the docking center 2 present in the docking region 2 (S520b).

Thereafter, the dockee transmits docking discovery to the docking center 2 in order to recognize whether a docking service is supported (S530b).

Here, the procedure for transmitting the docking discovery differs in an infrastructure environment and in a direct-connection environment.

Referring to FIG. 5B, in the infrastructure environment, the dockee broadcasts docking discovery to the docking center 1 and the docking center 2, and receives a response with respect to the docking discovery from the docking center 1 and the docking center 2 in a unicast manner, separately, to recognize information of a nearby docking center.

However, in the direct-connection environment, the dockee recognizes information regarding the docking center 1 and the docking center 2 after performing all of connection establishments of the data link layer with the docking center 1 and the docking center 2.

Thereafter, the docking center 2 transmits peripheral information obtainment request to the peripheral 2 dependent on the docking center 2 (S540b).

Thereafter, the peripheral 2 transmits peripheral information response including detailed information of the peripheral 2, as a response with respect to the peripheral information obtainment request, to the docking center 2 (S550b).

Thereafter, the docking center 2 transmits docking center information to the dockee (S560b).

Thereafter, in a case in which the Wi-Fi Layer 2 connection between the dockee and the docking center 2 is released (S570b), the dockee performs Wi-Fi Layer 2 connection establishment procedure with the docking center 1 present in the docking region #1 (S580b).

Thereafter, a procedure performed between the dockee and the docking center 1 is the same as steps S520b to S570B, and thus, a detailed description thereof will be omitted.

Thereafter, when the Wi-Fi Layer 2 connection between the dockee and the docking center 1 is released, the dockee re-selects the docking center 2 so as to be supported with the docking service.

Thereafter, a procedure performed by the dockee with the docking center 2 is the same as steps S520b to S570b, and thus, a detailed description thereof will be omitted.

Docking Pairing

Hereinafter, a docking pairing procedure in a wireless docking system proposed in the present disclosure will be described.

A docking pairing procedure is a procedure for docking connection between a dockee and a docking center, which may also be expressed as a docking session connection procedure.

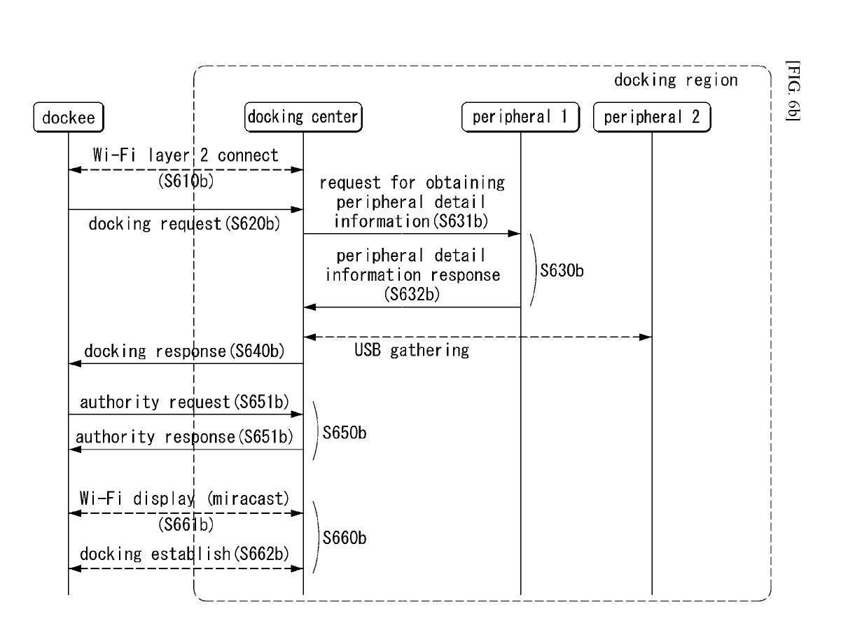

FIG. 6A is a flow chart illustrating an example of a docking pairing procedure in a wireless docking system proposed in the present disclosure.

First, the dockee performs an L2 connection and a docking discovery procedure with the docking center (S610a).

Thereafter, the dockee selects a docking center to perform a docking service by a user or through different conditions. Here, the different conditions may be a proximity distance between the dockee and the docking center, signal strength of a searched docking center, and hardware capacity of a docking center.

Thereafter, for pairing with a selected docking center, the dockee transmits a docking request (Docking Req) to the Jockey center in a unicast manner (S620a). The docking request includes information regarding a peripheral of the dockee.

The docking request includes information as illustrated in Table 9 below.

TABLE 9
<Docking_Req>

| | | Selective | |
|---|---|---|---|
| Parameter | Type | Value | Description |
| Docking_Center_ID | Unsigned Int | None | Docking Center |
| | | | ID value |
| Dockee_ID | Unsigned Int | None | Dockee_ID |
| | | | value |
| Dev_name | String | None | Dockee Device |
| | | | Name |
| Num_Peripheral | Unsigned Int | None | Number of |
| | | | supportable |
| | | | Peripheral |
| Peripheral_List | Structure Array | None | Detailed |
| | (Peripheral_Info_t) | | Information of |
| | | | Peripheral list |

In Table 9, the Dev name parameter denotes the name of a dockee (device), and the Num Peripheral parameter denotes the number of supportable peripherals or the number of peripheral functions able to perform a peripheral function by the dockee. The Peripheral_List parameter denotes detailed information of a peripheral list, details thereof will be referred to Table 10 below.

TABLE 10
<Peripheral_Info_t>

| | | Selective | |
|---|---|---|---|
| Parameter | Type | Value | Description |
| Peripheral_ID | Unsigned Int | None | Peripheral ID value |
| Dev_name | String | None | Device Name |
| Peripheral_Type | Enum | Mouse | Usable Device Type |
| | | Keyboard | |
| | | Printer/Scanner | |
| | | Display | |
| | | Home | |
| | | Automation | |
| | | . . . | |
| RW_Mode | Enum | Read Only | RW mode for |
| | | Write Only | Peripheral |
| | | Read/Write | |
| Display_Func | Boolean | Enable/Disable | Ability for Display |
| | | | Function |
| Conn_Type | Enum | USB | Connection Type to |
| | | Bluetooth | Docking Center |
| | | WiFi Serial Bus | |
| | | Wireless USB | |
| | | NFC | |
| | | . . . | |
| Condition | Boolean | Normal/Error | Peripheral Condition |
| Status | Enum | Able to be | Ability to accessible |
| | | Preempted | |
| | | Sharable | |
| | | Fully Shared | |
| Ordinal_Num | Unsigned Int | None | If ( Status == |
| | | | ‘Fully Shared’ ) |
| | | | Ordinal Number in |
| | | | Queue |

In Table 10, the Conn_Type parameter denotes a connection type in which the peripheral is connected with a docking center, which may be a USB, Bluetooth, Wi-Fi Serial Bus, Wireless USB, or NFC according to set values. The Condition parameter denotes a state of a peripheral, which indicates normal or error according to values. The Status parameter denotes connectable capability and indicates preemption, share or complete share according to set values. The Ordinal_Num parameter denotes a general number in a queue when a state is ‘complete share’.

Thereafter, the docking center performs a procedure for collecting a list of peripherals which can be controlled by the docking center or a list peripherals dependent on the docking center and detailed information of each peripheral, with the peripheral (S630a).

That is, the docking center transmits peripheral detailed information request (Get_Peri_Detail_Info) to the peripheral (5631 a), and the peripheral transmits peripheral detailed information response message with respect to the peripheral detailed information request to the docking center (S632a).

The peripheral detailed information request includes information items illustrated in Table 11 below.

TABLE 11
<Get_Peri_Detail_Info>

| | | Selective | |
|---|---|---|---|
| Parameter | Type | Value | Description |
| Docking_Center_ID | Unsigned Int | None | Docking |
| | | | Center ID |
| | | | value |
| Peripheral_ID | Unsigned Int | None | Peripheral |
| | | | ID value |

Also, the peripheral detailed information response (Peri Detail Info) includes information items illustrated in Table 12 below.

TABLE 12
<Peri Detail Info>

| | | Selective | |
|---|---|---|---|
| Parameter | Type | Value | Description |
| Docking_Center_ID | Unsigned Int | None | Docking |
| | | | Center ID |
| | | | value |
| Num_Connected_Dock- | Unsigned Int | None | Number of |
| ing_Center | | | connected |
| | | | Docking |
| | | | Center |
| Peripheral_Info | Periph- | None | Detailed |
| | eral_Info_t | | Peripheral |
| | | | Information |

In Table 12, the Num_Connected_Docking_Center parameter denotes the number of connected cocking centers, and the Peripheral_Infor denotes detailed peripheral information. Details thereof may be referred to Table 10.

Thereafter, the docking center transmits a docking response (Docking_Rsp) message including peripheral information and docking center information to the dockee (S640a).

The docking response (Docking_Rsp) message includes information items illustrated in Table 13 below.

TABLE 13
<Docking_Rsp>

| | | Selective | |
|---|---|---|---|
| Parameter | Type | Value | Description |
| Dockee ID | Unsigned int | None | Dockee ID |
| | | | value |
| Docking Center ID | Unsigned int | None | Docking |
| | | | Center ID |
| | | | value |
| Dev name | String | None | Docking |
| | | | Center |
| | | | Device Name |
| Num Peripheral | Unsigned int | None | Number of |
| | | | supportable |
| | | | Peripheral |
| Peripheral List | Structure Array | None | Detailed |
| | (Peripheral_Info_t) | | Information |
| | | | of Peripheral |
| | | | list |

In Table 13, the Num Peripheral parameter denotes the number of supportable peripherals, and the Peripheral List Parameter denotes detailed information of a peripheral list. Details of the Peripheral List parameter may be referred to Table 10.

Thereafter, the dockee performs an authorization procedure 650a with the docking center to request transfer of authority to control a peripheral desired to be controlled by the dockee.

That is, the dockee transmits an authority request (Authority_Req) including a list of at least one peripheral to the docking center (S651a).

The authority request (Authority_Req) message includes information items as illustrated in Table 14 below.

TABLE 14
<Authority_Req>

| | | Selective | |
|---|---|---|---|
| Parameter | Type | Value | Description |
| Docking_Center_ID | Unsigned Int | None | Docking |
| | | | Center ID |
| | | | value |
| Dockee_ID | Unsigned Int | None | Dockee ID |
| | | | value |
| Num_Peripheral | Unsigned Int | None | Number of |
| | | | Peripheral |
| | | | for control |
| Peripheral_List | Structure Array | None | Detailed |
| | (Authority_Info_t) | | Information |
| | | | of Peripheral |
| | | | list for |
| | | | control |

In Table 14, the Num_Peripheral parameter denotes the number of peripherals to be controlled, and the Peripheral_List parameter denotes detailed information of a peripheral list to be controlled. Details of the Peripheral_List parameter may be referred to Table 15 below.

TABLE 15
<Authority_Info_t>

| | | Selective | |
|---|---|---|---|
| Parameter | Type | Value | Description |
| Peripheral_ID | Unsigned Int | None | Docking |
| | | | Center ID |
| | | | value |
| Dev_name | String | None | Device Name |
| Peripheral_Type | Enum | Mouse | Usable Device |
| | | Keyboard | Type |
| | | Printer/Scanner | ( [symbol] ) |
| | | Display | |
| | | Home Automation | |
| | | . . . | |
| RW_Mode | Enum | Read Only | RW mode for |
| | | Write Only | Peripheral |
| | | Read/Write | |
| Display_Func | Boolean | Enable/Disable | Ability for |
| | | | Display |
| | | | Function |
| Authority_Type | Boolean | Preemption/ | Connection |
| | | Share | Type to |
| | | | Docking |
| | | | Center |

In Table 15, the RW_Mode parameter denotes a read/write mode of a peripheral, and only a read function, only a write function, or both read and write functions may be available according to set values. The Display_Func parameter denotes whether to perform a display function, and may be indicated to be available or unavailable according to set values. The Authority_Type parameter denotes a type connected to the docking center, and may be preemption or share according to set values.

Thereafter, the docking center checks the peripheral list received from the dockee, and transmits an authority response (Authority_Rsp) message including whether each peripheral is permitted to the dockee (S652a).

The authority response (Authority_Rsp) message includes information items illustrated in Table 16 below.

TABLE 16
<Authority_Rsp>

| | | Selective | |
|---|---|---|---|
| Parameter | Type | Value | Description |
| Docking_Center_ID | Unsigned Int | None | Dockee ID |
| | | | value |
| Dockee_ID | Unsigned Int | None | Docking |
| | | | Center ID |
| | | | value |
| Num_Peripheral | Unsigned Int | None | Number of |
| | | | agreed |
| | | | Peripheral |
| | | | for control |
| Peripheral_List | Structure Array | None | Detailed |
| | (Authority_Info_t) | | Information |
| | | | of agreed |
| | | | Peripheral |
| | | | list for |
| | | | control |

In Table 16, the Num_Peripheral parameter denotes the number of peripherals permitted to be controlled, and the Peripheral_List parameter denotes detailed information of the peripheral list permitted to be controlled. Details of the Peripheral_List parameter may be referred to Table 15.

Thereafter, the dockee and the docking center are in a docking established, completing the docking pairing procedure (S660a).

FIG. 6B is a flow chart illustrating another example of a docking pairing procedure in a wireless docking system proposed in the present disclosure.

As illustrated in FIG. 6B, the docking center, the peripheral 1 and the peripheral 2 are present in the docking region.

The peripheral 1 and the peripheral 2 may be dependent on the docking center or may be controlled by the docking center. The peripheral 1 is a docking-dedicated peripheral, and the peripheral 2 is a USB.

First, the dockee establishes a Wi-Fi layer 2 connection establishment with the docking center (S610b).

Thereafter, for pairing with the docking center (that is, for a docking session connection), the dockee transmits a docking request to the docking center (S620b). The docking request includes peripheral information of the dockee.

Thereafter, the docking center performs a procedure for collecting detailed information of the peripheral 1 and the peripheral 2 with the peripheral 1 and the peripheral 2 (630b).

First, the docking center transmits peripheral detailed information obtainment request to the peripheral 1 (S631 b), and the peripheral 1 transmits peripheral detailed information response message including detailed information thereof to the docking center, as a response to the peripheral detailed information obtainment request (S632b).

Also, the docking center receives detailed information regarding the peripheral 2 through a USB device gathering process with the peripheral 2. As the USB device gathering procedure, a USB standard technique is applied.

Thereafter, the docking center transmits a docking response message including information of the peripheral 1, the peripheral 2, and the docking center, to the dockee (S640b).

Thereafter, the dockee performs an authority procedure for transferring authority to control a peripheral with the docking center (S650b).

Thereafter, a Wi-Fi display (miracast) is initialized between the dockee and the docking center, and a docking connection is established (S660b).

Docking Operation

Hereinafter, a docking operation in the wireless docking system proposed in the present disclosure will be described in detail.

When the pairing procedure between the dockee and the docking center is completed in the wireless docking system, the dockee may be controlled by using peripherals paired based on the docking center, without directly controlling the dockee.

In the wireless docking system, the docking operation is managed in an event-driven manner or in a periodic manner.

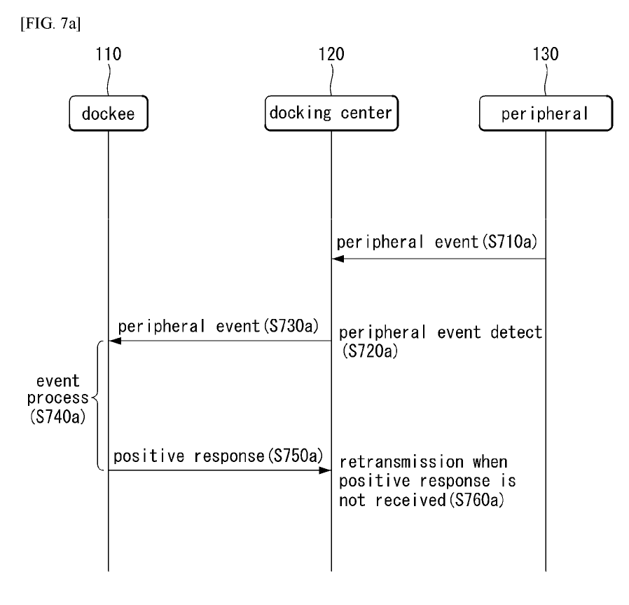

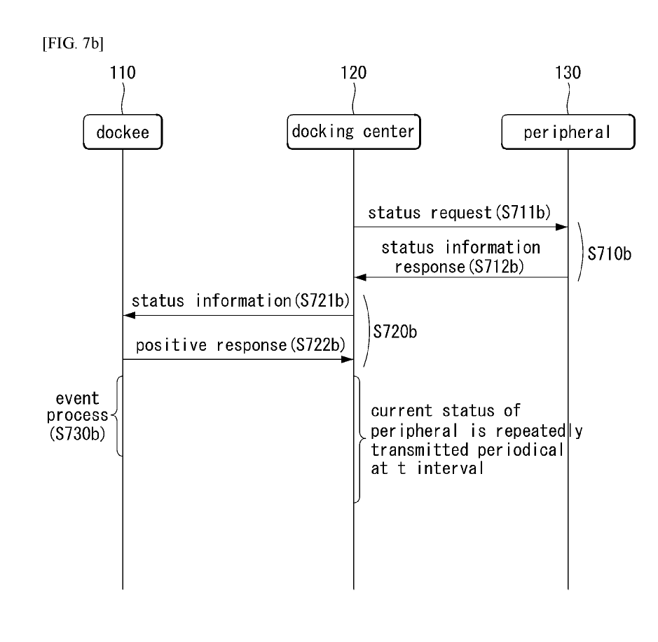

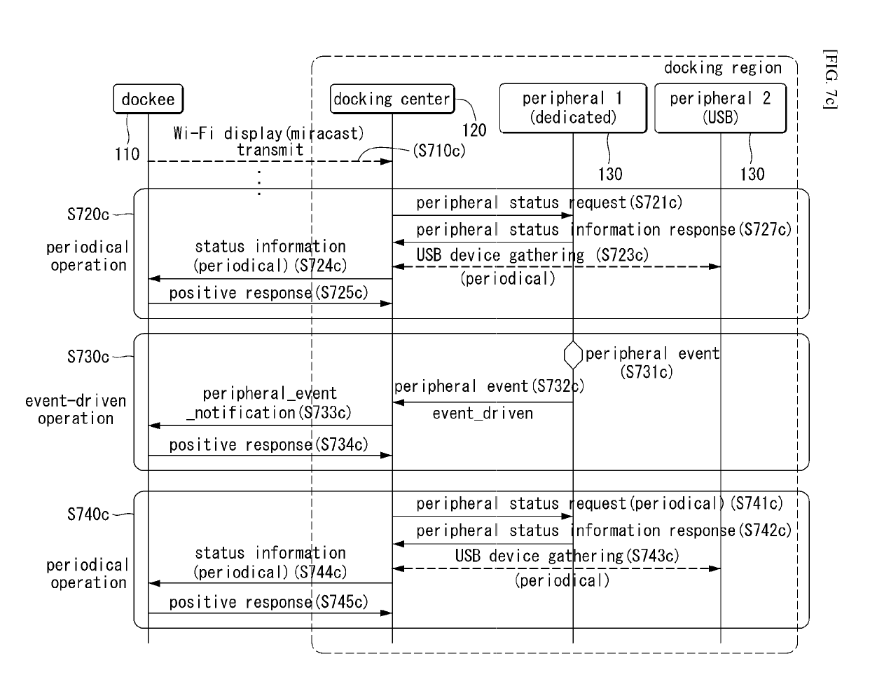

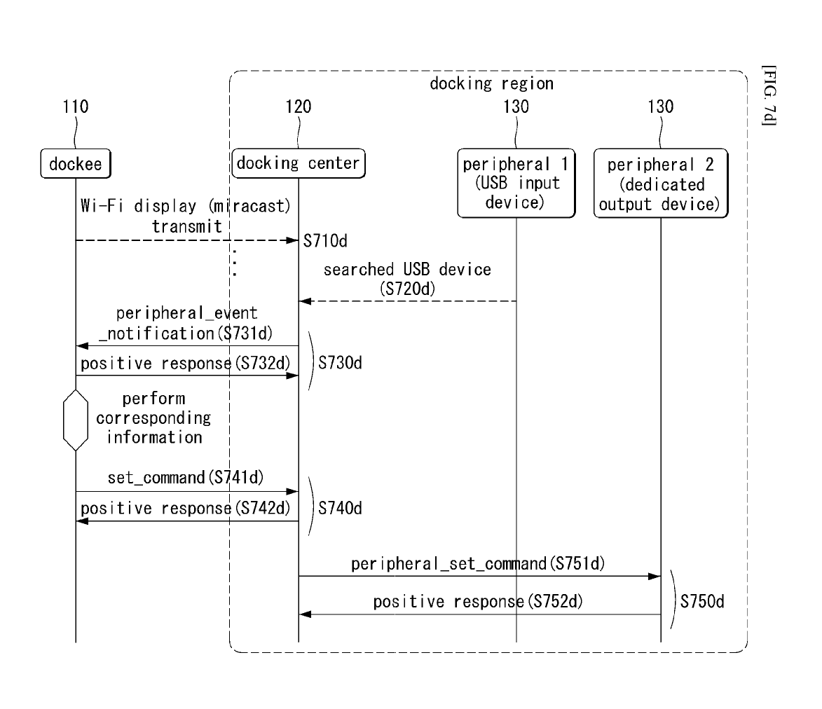

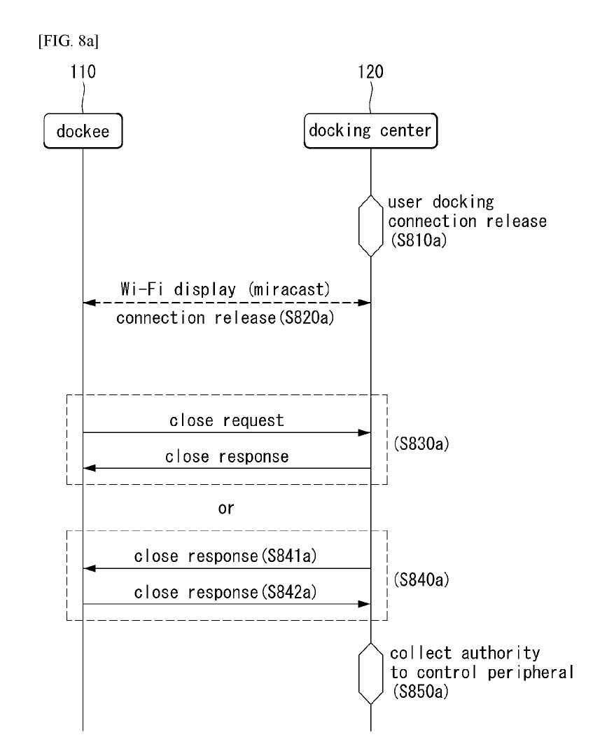

First, the event-driven type docking operation in the wireless docking system will be described with reference to FIG. 7A.

Peripheral information generated due to manipulation of a peripheral such as a mouse or a keyboard is managed through the event-driven type docking operation. That is, when an event occurs in a peripheral, peripheral information of the generated event is transmitted to the dockee through the docking center.

FIG. 7A is a flow chart illustrating an example of an event-driven type docking operation procedure.

When an event occurs in a peripheral, the peripheral transmits a peripheral event (Peripheral_Event) message including the generated event information to the docking center (S710a).

The peripheral event (Peripheral_Event) message includes information items illustrated in Table 17 below.

TABLE 17
<Peripheral_Event>

| | | Selective | |
|---|---|---|---|
| Parameter | Type | Value | Description |
| Docking_Center_ID | Unsigned Int | None | Docking |
| | | | Center ID |
| | | | value |
| Num_Connected_Dock- | Unsigned Int | None | Number of |
| ing_Center | | | connected |
| | | | Docking |
| | | | Center |
| Peripheral_Info | Periph- | None | Detailed |
| | eral_Info_t | | Peripheral |
| | | | Information |
| | | | (See Table 10) |
| Action_Profile | USB_HID_t | None | HID Profile |
| | | | Data defined |
| | | | in USB |
| Data | Variable Length | None | Required data |
| | | | in addition |
| | | | to Peripheral |
| | | | Action Profile |

Thereafter, when the event of the peripheral is detected through the peripheral event message reception (S720a), the docking center transmits a peripheral event notification (Peripheral_Event_Noti) message including the event information generated in the peripheral to the dockee (S730a).

The peripheral event message transmitted by the docking center to the dockee includes information items illustrated in Table 18 below.

TABLE 18
<Peripheral_Event_Noti>

| | | Selective | |
|---|---|---|---|
| Parameter | Type | Value | Description |
| Dockee_ID | Unsigned Int | None | Dockee ID |
| | | | value |
| Docking_Center_ID | Unsigned Int | None | Docking |
| | | | Center ID |
| | | | value |
| Peripheral_Info | Peripheral_Info_t | None | Detailed |
| | | | Peripheral |
| | | | Information |
| | | | (See Appendix) |
| Action_Profile | USB_HID_t | None | HID Profile |
| | | | Data defined |
| | | | in USB |
| Data | Variable Length | None | Required data |
| | | | in addition |
| | | | to Peripheral |
| | | | Action Profile |

Thereafter, the dockee processes the corresponding event by using the peripheral event message (S740a), and transmits a positive acknowledgement (ACK) regarding the processed event to the docking center (S750a).

Here, in a case in which the docking center fails to receive the ACK during a predetermined period of time from the dockee, the docking center retransmits the peripheral event message to the dockee (S760a).

The number of retransmissions of the peripheral event message may be a maximum of 3 times or 5 times, but the present disclosure is not limited thereto.

FIG. 7B is a flow chart illustrating an example of a periodic type docking operation procedure in a wireless docking system proposed in the present disclosure.

Unlike the event-driven type docking operation, the periodic type docking operation is that a docking center periodically informs the dockee about a current status of a peripheral.

A peripheral event occurring in real time may be solve in the event-driven manner, but in case of a peripheral in which an event has not occurred for a long period of time, it is difficult for the dockee to recognize current status information of the peripheral and past status information of the peripheral is not also reliable.

Thus, the docking center collects information of a peripheral dependent on the docking center from the corresponding peripheral and transmits the corresponding information to the dockee at a predetermined time interval.

As illustrated in FIG. 7B, in order to request information regarding a current status of the peripheral, the docking center transmits a status request (Status_Req) message to the peripheral (S711b).

The status request or the peripheral status request message includes information items illustrated in Table 19 below.

TABLE 19
<Status_Req or Peri_Status_Req>

| | | Selective | |
|---|---|---|---|
| Parameter | Type | Value | Description |
| Docking_Center_ID | Unsigned Int | None | Docking |
| | | | Center ID |
| | | | value |
| Peripheral_ID | Unsigned Int | None | Peripheral |
| | | | ID value |

Thereafter, the peripheral transmits status information (Status_Info) message or status response (Status_Rsp) message including its current status information to the docking center (S712b).

The status information or the status response message includes information items illustrated in Table 20 below.

TABLE 20
<Peri_Status_Info>

| | | Selective | |
|---|---|---|---|
| Parameter | Type | Value | Description |
| Docking_Center_ID | Unsigned Int | None | Docking |
| | | | Center ID |
| | | | value |
| Num_Connected_Docking_Center | Unsigned Int | None | Number of |
| | | | connected |
| | | | Docking |
| | | | Center |
| Peripheral_Info | Peripheral_Info_t | None | Detailed |
| | | | Peripheral |
| | | | Information |
| | | | (See Table 10) |
| Action_Profile | USB_HID_t | None | HID Profile |
| | | | Data defined |
| | | | in USB |
| Data | Variable Length | None | Required data |
| | | | in addition to |
| | | | Peripheral |
| | | | Action Profile |

In table 20, the Num_Connected_Docking_Center parameter denotes the number of connected docking center, the Peripheral_Info parameter denotes detailed peripheral information, and the Action Profile parameter denotes data of an HID profile defined in the USB.

The Data parameter denotes required data in addition to the peripheral Action Profile parameter.

Thereafter, the docking center transmits the status information message received from the peripheral to the dockee (S721b).

The status information message transmitted to the dockee includes information items illustrated in Table 21 below.

TABLE 21
<Status_Info>

| | | Selective | |
|---|---|---|---|
| Parameter | Type | Value | Description |
| Dockee_ID | Unsigned Int | None | Dockee ID |
| | | | value |
| Docking_Center_ID | Unsigned Int | None | Docking Center |
| | | | ID value |
| Num_Peripheral | Unsigned Int | None | Number of |
| | | | Peripheral for |
| | | | control |
| Peripheral_Info_List | Structure Array | None | Detailed |
| | (Peripheral_Info_t) | | Peripheral |
| | | | Information |
| | | | (See Table 10) |
| Action_Profile_List | Structure Array | None | HID Profile |
| | (USB_HID_t) | | Data defined in |
| | | | USB |
| Data_List | Data Array | None | Required data |
| | | | in addition to |
| | | | Peripheral |
| | | | Action Profile |

In Table 21, the Num_Peripheral parameter denotes the number of peripherals to be controlled, and the Peripheral_Info_List parameter denotes a detailed peripheral information list. Details may be referred to Table 10. The Action_Profile_List parameter denotes an HID Profile data List defined in a USB, and the Data_List parameter denotes required data List in addition to the Peripheral Action Profile.

Thereafter, the dockee transmits ACK as a positive acknowledgement with respect to the received status information message (S722b).

Thereafter, the dockee performs event processing using the received status information message (S730b). Here, event processing refers to a process of updating status information of a peripheral, and the event processing in the dockee is performed in the same manner as that of the event-driven scheme.

Also, the docking operation may be performed by the docking center on the basis of one selected from the event-driven scheme and the periodic scheme or on the basis of a mixture form thereof.

FIG. 7C is a flow chart illustrating an example of a docking operation procedure using both the event-driven scheme and the periodic scheme in a wireless docking system using Wi-Fi proposed in the present disclosure.

As illustrated in FIG. 7C, the docking center, the docking-dedicated peripheral 1 and a USB peripheral 2 are present in the docking region.

The dockee sends a Wi-Fi display (miracast) transmission to the docking center (S710c).

Here, the miracast refers to a technique of transmitting a screen by using Wi-Fi, that is, a technique based on which when a screen, a sound, data provided from a monitor or a speaker are compressed and transmitted by Wi-Fi, and a receiver decompresses the corresponding data and displays the same on a screen.

Thereafter, in order to inform the dockee about the status of the peripheral 1 and the peripheral 2, the docking center performs the periodic type docking operation procedure with the peripheral 1 and the peripheral 2 (S720c).

Steps S721c to S725c are the same as steps S710b to S730b of FIG. 7B, and thus, a detailed description thereof will be omitted.

Thereafter, when an event occurs in the peripheral 1, the docking center, the dockee, and the peripheral 1 perform the event-driven type docking operation procedure (S730c).

That is, when the peripheral 1 detects occurrence of a event (S731c), the peripheral 1 transmits a peripheral event (Peripheral_Event) message including the generated event information to the docking center (S732c). Also, the docking center transmits a peripheral event notification (Peripheral_Event_Noti) message indicating that the event has occurred in the peripheral 1 to the dockee (S733c). On the basis of the received peripheral event notification message, the dockee performs event processing and transmits an ACK as a response to the peripheral event notification message (S734c).

When an event does not occur during a predetermined period of time, the period type docking operation procedure of step S720c is performed (S740c).

FIG. 7D is a flow chart illustrating an example of a docking operation procedure according to a user command in a wireless docking system using Wi-Fi proposed in the present disclosure.

Here, the docking operation procedure according to a user command refers to outputting to an output device by using an input device.

As illustrated in FIG. 7D, the docking center, the peripheral 1 as a USB input device, and the peripheral 2 as a dedicated output device are present in the docking region.

The dockee sends a Wi-Fi display (miracast) transmission to the docking center (S710d).

Thereafter, when information indicating that the USB device as the peripheral 1 has been detected is received from the peripheral 1, the docking center transmits a peripheral event notification (Peripheral_Event_Noti) message indicating that the peripheral 1 has been detected, to the dockee (S731d).

Thereafter, the dockee transmits an ACK as a response to the peripheral event notification message to the docking center (S732d).

Thereafter, when the dockee receives a user command, the dockee transmits a set command (Set_Command) message including the received command to the docking center (S741d).

The set command (Set_Command) message transmitted from the dockee to the docking center includes information items illustrated in Table 22 below.

TABLE 22
<Set_Command>

| | | Selective | |
|---|---|---|---|
| Parameter | Type | Value | Description |
| Dockee_ID | Unsigned Int | None | Dockee ID |
| | | | value |
| Docking_Center_ID | Unsigned Int | None | Docking Center |
| | | | ID value |
| Peripheral_Info | Peripheral_Info_t | None | Detailed |
| | | | Peripheral |
| | | | Information |
| | | | (See Table 10) |
| Action_Profile | USB_HID_t | None | HID Profile |
| | | | Data defined |
| | | | in USB |
| Data | Variable Length | None | Required data |
| | | | in addition to |
| | | | Peripheral |
| | | | Action Profile |

Thereafter, the docking center transmits an ACK, as a response to the set command message, to the dockee (S742d).

Thereafter, on the basis of the received set command message, the docking center transmits a peripheral set command (Peri_Set_Command) message to the peripheral 2 (S751d).

The peripheral set command (Peri_Set_Command) message transmitted from the docking center to the peripheral includes information items illustrated in Table 23 below.

TABLE 23
<Peri_Set_Command>

| | | Selective | |
|---|---|---|---|
| Parameter | Type | Value | Description |
| Dockee_ID | Unsigned Int | None | Dockee ID |
| | | | value |
| Docking_Center_ID | Unsigned Int | None | Docking Center |
| | | | ID value |
| Peripheral_Info | Peripheral_Info_t | None | Detailed |
| | | | Peripheral |
| | | | Information |
| | | | (See Appendix) |
| Action_Profile | USB_HID_t | None | HID Profile |
| | | | Data defined |
| | | | in USB |
| Data | Variable Length | None | Required data |
| | | | in addition to |
| | | | Peripheral |
| | | | Action Profile |

Thereafter, the peripheral 2 transmits an ACK, as a response to the peripheral set command message, to the docking center (S752d).

Docking Closing

Hereinafter, a docking closing procedure in the wireless docking system proposed in the present disclosure will be described in detail.

The docking closing procedure includes two types of docking closing, that is, docking closing based on a user request and docking closing based on time-out.

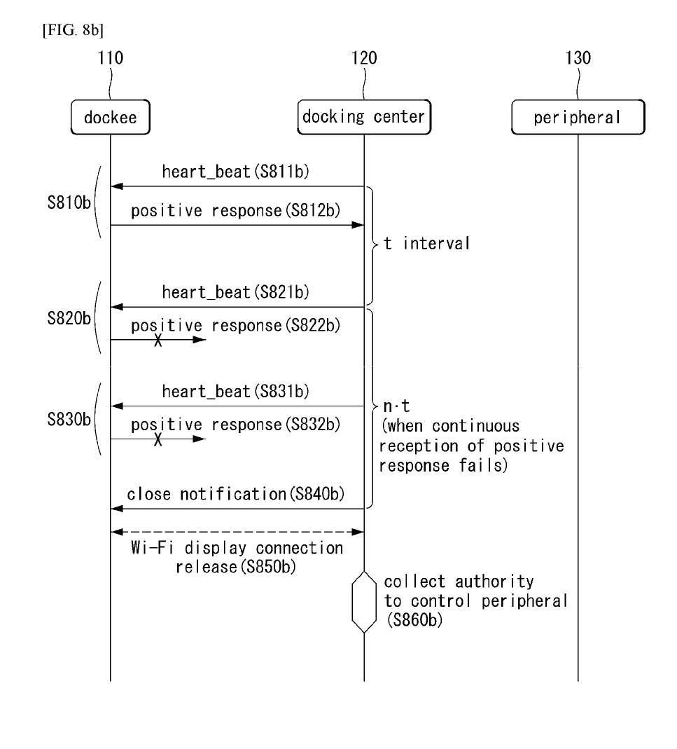

First, the docking closing procedure based on a user request will be described with reference to FIG. 8A.

FIG. 8A is a flow chart illustrating an example of a docking closing procedure based on a user request.

As illustrated in FIG. 8A, the docking closing procedure based on a user request may be started by the dockee or by the docking center.

The docking center or the dockee receives a docking connection release from the user (S810a), the docking center performs Wi-Fi display (miracast) connection release with the dockee (S820a).

Thereafter, the dockee and the docking center perform the docking service usage termination procedure. First, a case in which the dockee requests usage closing from the docking center will be described.

The dockee transmits a close request (Close_Req) message for closing the docking service usage to the docking center (S830a).

Then, the docking center transmits a close response (Close_Req) message, as a response to the close request message, to the dockee (S830a).

Next, a case in which the docking center requests usage closing from the dockee will be described.

The docking center transmits a close request (Close_Req) message for closing docking usage to the dockee (S840a).

Then, the dockee transmits a close response (Close_Rsp) message, as a response to the closing request, to the docking center (S840a).

Thereafter, the docking center collects the authority to control the peripheral from the dockee (S850a).

The close request (Close_Req) message transmitted from the docking center to the dockee or from the dockee to the docking center includes information items illustrated in Table 24 below.

TABLE 24
<Close_Req>

| Parameter | Type | Selective Value | Description |
|---|---|---|---|
| Dockee_ID | Unsigned Int | None | Dockee ID value |
| Docking_Center_ID | Unsigned Int | None | Docking Center |
| | | | ID value |

Also, the close response (Close_Rsp) message transmitted from the docking center to the dockee or from the dockee to the docking center includes information items illustrated in Table 25 below.

TABLE 25
<Close_Rsp>

| Parameter | Type | Selective Value | Description |
|---|---|---|---|
| Dockee_ID | Unsigned Int | None | Dockee ID value |
| Docking_Center_ID | Unsigned Int | None | Docking Center |
| | | | ID value |

FIG. 8B is a flow chart illustrating an example of a docking closing procedure based on time-out.

In some cases, the dockee and the docking center paired in the wireless docking system may need to close the docking connection due to an inevitable cause such as communication interruption, or the like.

In this case, the docking center should collect the authority to control the peripheral given to the dockee and prepare paring with another dockee.

In order to perform such a function, a method for periodically checking whether a connection between the docking center and the dockee is maintained is required.

Thus, in the present disclosure, a method for exchanging a heart beat (Heart_beat) message for periodically checking whether a connection between the docking center and the dockee is maintained is provided.

For example, as illustrated in FIG. 8B, the docking center continuously transmits a heat_beat (Heart_beat) message for periodically checking whether a connection between the docking center and the dockee is maintained to the dockee at a predetermined time interval by a preset number of times (n) (S811b).

The heart beat (Heart_Beat) message includes information items illustrated in Table 26 below.

TABLE 26
<Heart_Beat>

| Parameter | Type | Selective Value | Description |
|---|---|---|---|
| Dockee_ID | Unsigned Int | None | Dockee ID value |
| Docking_Center_ID | Unsigned Int | None | Docking Center |
| | | | ID value |

In FIG. 8B, the preset number of times is set to 3 times, but this is merely an example and the number of may be flexibly set to twice, four times, or five times according to system environments.

Also, preferably, the predetermined time interval is set to 1 second, but this value may also be flexibly set according to system environments.

Thereafter, the dockee transmits an ACK to the docking center, as a response with respect to the heart bit message (S812b).

Here, in a case in which the docking center does not receive any one ACK with respect to heart beat messages which have been transmitted to the dockee, from the dockee, the docking center determines that communication with the dockee is interrupted and transmits a close notification (Close_Notification) message for releasing docking connection, to the dockee (S820b to S840b).

The close notification (Close_Notification) message includes information items illustrated in Table 27 below.

TABLE 27
<Close_Notification>

| Parameter | Type | Selective Value | Description |
|---|---|---|---|
| Dockee_ID | Unsigned Int | None | Dockee ID value |
| Docking_Center_ID | Unsigned Int | None | Docking Center |
| | | | ID value |

Here, the close notification message is transmitted from the docking center over a possibility that the dockee will be able to receive the message.

When the docking center transmits the close notification message, the Wi-Fi display between the dockee and the docking center is released from connection (S850b).

Thereafter, the docking center collects the authority to control the peripheral which has been transferred to the dockee, from the dockee (S860b).

FIG. 8B illustrates a case in which the heart beat (Heart_beat) message for periodically checking whether a connection between the docking center and the dockee is maintained is transmitted by the docking center, but this is merely an example, and in order to periodically check whether a connection between the docking center and the dockee is maintained, the heart beat message may be transmitted by the dockee and the docking center may transmit a response thereto.

Hereinafter, a dedicated peripheral interface proposed in the present disclosure will be described in detail.

In the wireless docking system, the docking center uses a standard interface such as a USB or Bluetooth.

However, in a case in which there is a request for using only a peripheral without connection to the docking center and the dockee, such as a lighting system or home automation, in the wireless docking system, a separate interface for docking between the docking center and the peripheral is required.

Thus, a communication interface between the docking center and a docking-dedicated peripheral is defined.

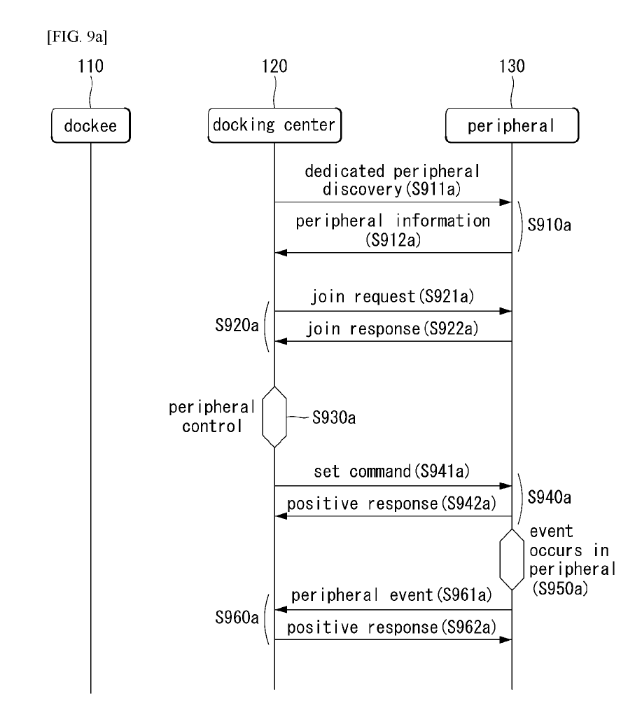

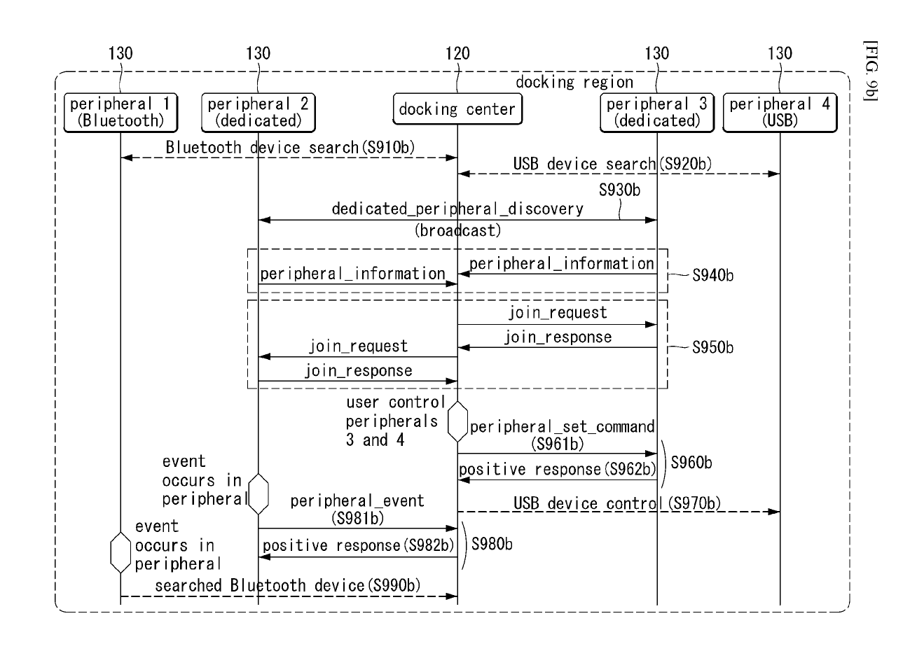

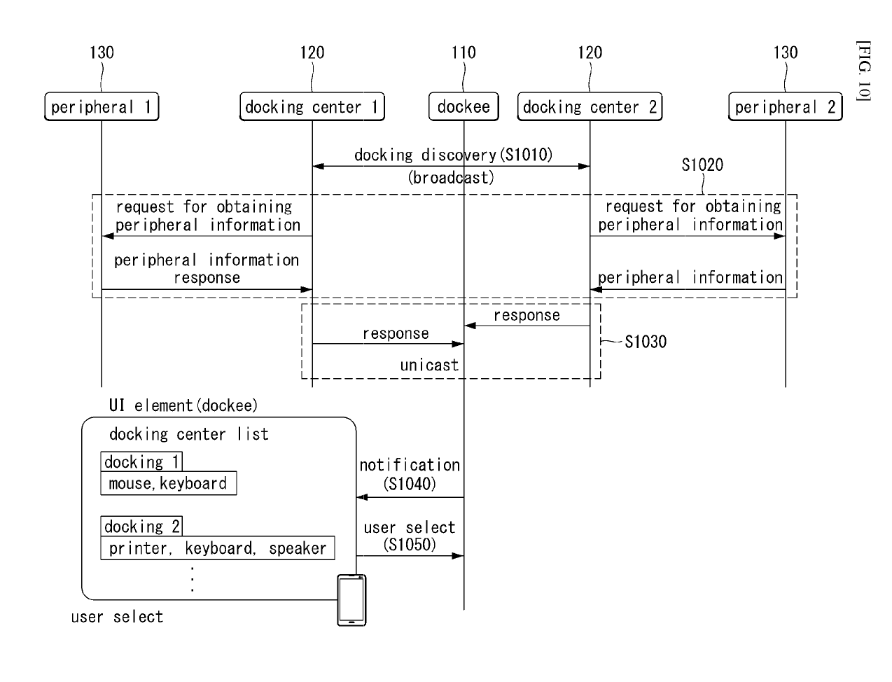

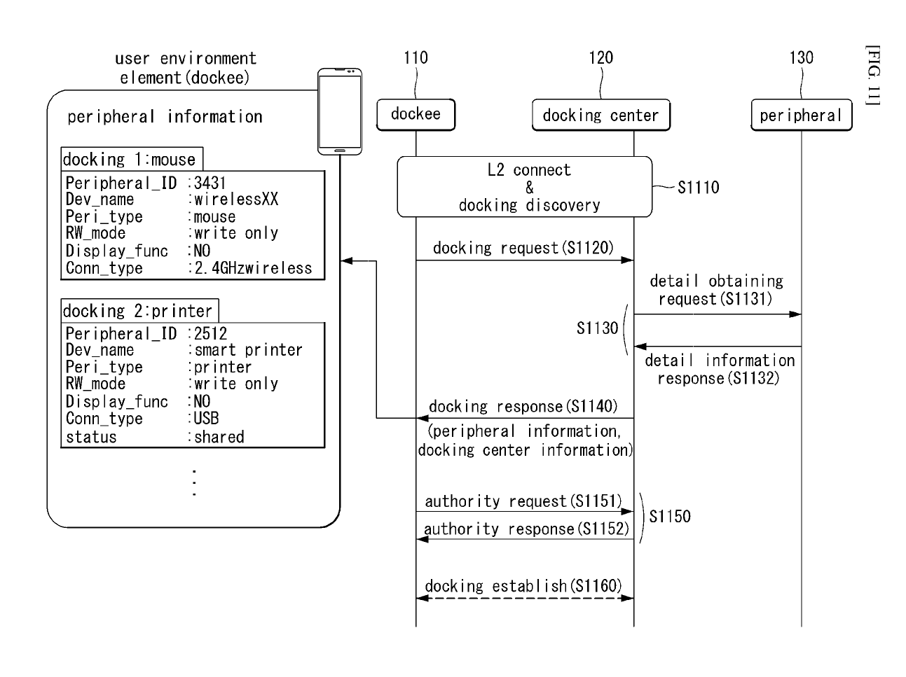

FIG. 9A is a flow chart illustrating an example of a communication procedure between a docking center and a docking-dedicated peripheral proposed in the present disclosure.

First, in order to recognize a dedicated peripheral present nearby (or in proximity, in the vicinity, or within a close distance), the docking center broadcasts a dedicated peripheral discovery (Dedicated_Peri_Discovery) message (S911a).

The dedicated peripheral discovery message includes information items illustrated in Table 28 below.

TABLE 28
<Dedicated_Peri_Discovery>

| Parameter | Type | Selective Value | Description |
|---|---|---|---|
| Docking_Center_ID | Unsigned Int | None | Docking Center |
| | | | ID value |

Thereafter, when a dedicated peripheral receives the dedicated peripheral discovery message, the dedicated peripheral transmits peripheral information (Peripheral_Info) message including device information thereof to the docking center (S912a).

The peripheral information message includes information items illustrated in Table 29 below.

TABLE 29
<Peripheral_Info>

| | | Selective | |
|---|---|---|---|
| Parameter | Type | Value | Description |
| Docking_Center_ID | Unsigned Int | None | Docking Center |
| | | | ID value |
| Peripheral_Info | Peripheral_Info_t | None | Detailed |
| | | | Peripheral |
| | | | Information |
| | | | (See Table 10) |

Thereafter, on the basis of the peripheral information message received from the dedicated peripheral, the docking center selects a dedicated peripheral which is required to become dependent on the wireless docking system or which is required to be included in the wireless docking system.

Thereafter, the docking center performs a joining procedure or docking with the selected peripheral (S920a), thus completing a dedicated peripheral registration procedure with the peripheral.

In the joining procedure, the docking center transmits a join request (Join_Req) message to the selected peripheral (S921a), and the selected peripheral transmits a join response (Join_Rsp) message to the docking center, as a response to the join request message (S922a).

The join request (Join_Req) message includes information items illustrated in Table 30 below.

TABLE 30
<Join_Req>

| | | Selective | |
|---|---|---|---|
| Parameter | Type | Value | Description |
| Peripheral_Info | Unsigned Int | None | Docking Center ID |
| | | | value |
| Docking_Center_ID | Unsigned Int | None | Docking Center ID |
| | | | value |

Also, the join response (Join_Rsp) message includes information items illustrated in Table 31 below.

TABLE 31
<Join_Rsp>

| | | Selective | |
|---|---|---|---|
| Parameter | Type | Value | Description |
| Docking_Center_ID | Unsigned Int | None | Docking Center ID |
| | | | value |
| Peripheral_ID | Unsigned Int | None | Docking Center ID |
| | | | value |

In this manner, the docking center controls the peripheral (S930a).

Thereafter, in a case in which the dedicated peripheral is an output device which needs to be controlled, the docking center transmits a set command (Set_Command) message to the dedicated peripheral (S941a).

In this case, the dedicated peripheral transmits an ACK as a response to the set command message, to the docking center (S942a.

Also, in a case in which the dedicated peripheral is an input device which needs to be controlled, when an event occurs in the dedicated peripheral, the dedicated peripheral transmits a peripheral event (Peripheral_Event) message including the generated event information to the docking center (S961a).

In this case, the docking center transmits an ACK, as a response to the peripheral event message, to the dedicated peripheral (S962a).

FIG. 9B is a flow chart illustrating another example of a communication procedure between a docking center and a docking-dedicated peripheral proposed in the present disclosure.

FIG. 9B illustrates a procedure for defining an interface between the docking center and the docking dedicated peripheral in the wireless docking system using Wi-Fi.

As illustrated in FIG. 9B, the docking center, the peripheral 1 available for Bluetooth communication, docking-dedicated peripheral 2 and peripheral 3, and a peripheral available for USB communication are present in the docking region.

First, the docking center performs a Bluetooth device search procedure with the peripheral 1 (S910b), and performs a USB device search procedure with the peripheral 4 (S920b).

Thereafter, the docking center broadcasts a dedicated peripheral discovery (Dedicated_Peri_Discovery) message to the dedicated peripherals 2 and 3 (S930b).

Thereafter, the dedicated peripherals 2 and 3 each transmit a peripheral information (Peripheral_Info) message including each peripheral device information, as response to the dedicated peripheral discovery message, to the docking center (S940b).

Thereafter, on the basis of the peripheral information message received from the dedicated peripherals 2 and 3, the docking center selects a dedicated peripheral which needs to be dependent on the wireless docking system or which needs to be included therein.

Thereafter, the docking center performs a joining procedure with the dedicated peripherals 2 and 3 (S950b), thus completing a dedicated peripheral registration procedure with the dedicated peripherals 2 and 3.

The joining procedure for the docking center with the dedicated peripherals 2 and 3 is the same as the step S920a of FIG. 9A, and thus, a detailed description thereof will be omitted.

Thereafter, when the docking center receives a user request regarding control of the peripherals 3 and 4, the docking center transmits a set command (Set_Command) message to the peripheral 3 (S961b) and transmits a USB device control message for controlling a USB device to the peripheral 4 (S970b).

Here, the dedicated peripheral 3 transmits an ACK, as a response to the set command message, to the docking center (S962b).

Also, when an event occurs in the dedicated peripheral 2, the dedicated peripheral 2 transmits a peripheral event (Peripheral_Event) message including the generated event information to the docking center (S981b).

In this case, the docking center transmits an ACK to the peripheral 2, as a response with respect to the peripheral event message (S982b).

Also, when an event occurs in the dedicated peripheral 1, the peripheral 1 informs the docking center that the Bluetooth device has been searched (S990b).

Hereinafter, a user interface (UI) related to the docking discovery process proposed in the present disclosure will be described in detail.

A UI related to the wireless docking system is mainly generated in the dockee, and the UI is divided into a UI related to a docking center discovery procedure and a UI related to a pairing procedure.

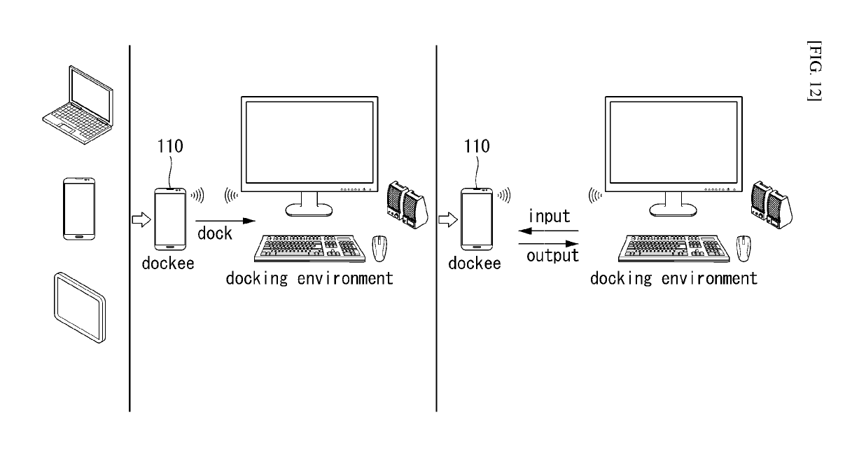

FIG. 10 is a view illustrating an example of a user interface related to a docking discovery procedure proposed in the present disclosure.

As illustrated in FIG. 10, when each docking center information and information of a peripheral dependent on each docking center are received from the docking center 1 and the docking center 2 through a docking discovery procedure (MAC layer or application layer), the dockee displays the received information through an output unit thereof (S1010 to S1030).

Detailed descriptions of steps S1010 to S1030 may be referred to FIGS. 4A through 5B.

As illustrated in FIG. 10, the information (S1040) displayed through the output unit of the dockee includes a docking center list in a searched neighbor environment and a list of peripherals controlled in each docking center. A docking center 1 and a docking center 2 are displayed in the docking center list. A mouse and a keyboard controlled in the docking center 1 are displayed in the peripheral list, and a printer, a keyboard, and a speaker are displayed as peripherals controlled in the docking center 2.

Here, a detail level of the peripheral information displayed on the UI screen of the dockee may be selectively provided by the user.

That is, detailed information of a peripheral may be processed to a summary form so as to be displayed, or the entirety of detailed information of a peripheral may be displayed at a time.

Also, the detailed information of the peripheral may be displayed together with the docking center list and the peripheral list on the same screen, or when a corresponding peripheral is clicked on the displayed peripheral list, detailed information of the corresponding peripheral may be displayed.

Thereafter, when an input for selecting any one docking center by the user in the UI screen of the dockee is received (S1050), the dockee performs a pairing procedure with the selected docking center.

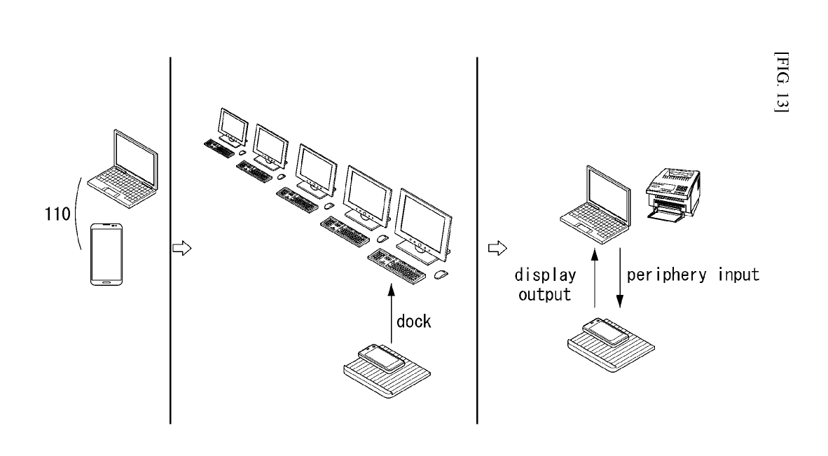

FIG. 11 is a view illustrating an example of a user interface related to a docking pairing procedure proposed in the present disclosure.

In the pairing procedure of the dockee and the docking center, detailed information regarding peripherals available to be used by the dockee is displayed.

In the detailed information regarding the peripherals, a physical or logical interface between the peripheral and the docking center may also be displayed together, and an attribute of each peripheral regarding whether input/output is available and whether each peripheral can be shared with other system are also displayed together.

As illustrated in FIG. 11, when the dockee receives a docking response message including information of a peripheral dependent on the docking center and the docking center information, the dockee displays detailed information of the periphery through the output unit thereof, that is, within the UI thereof (S1110 to S1140).

As illustrated in FIG. 11, detailed information of the peripheral displayed within the UI of the dockee may include a peripheral identifier (ID) for identifying a peripheral, a device name (Dev Name), a name of a peripheral, a peripheral type (Peri type) indicating a type of a peripheral, a read/write (R/W) mode indicating whether a read/write function is supported, a display function (Display func) indicating whether a peripheral has a display function, a connection type (Conn Type) indicating a connection type between the docking center and a peripheral, and status information (Status) indicating a connection state between a peripheral and other device.

Thereafter, the dockee and the docking center performs an authority request and authority response procedure (S1150), and a docking connection is established (S1160). The authority request and authority response procedure may be referred to step S650a of FIG. 6A.

Hereinafter, detailed situations in which the wireless docking system using Wi-Fi proposed in the present disclosure will be described.

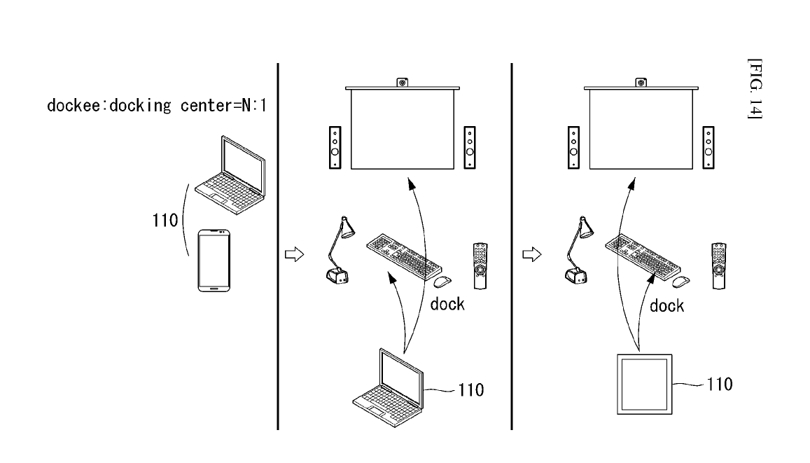

FIG. 12 is a view illustrating an example in which a wireless docking system using Wi-Fi proposed in the present disclosure is utilized in a house or an office.

In FIG. 12, it is assumed that a portable device (e.g., smartphone) is a dockee (wireless dockee (WD)), a monitor in a house or an office is a docking center (wireless docking center (WDC)), and a keyboard, a mouse, and a speaker are peripherals.

That is, descriptions of the components constituting the wireless docking system of FIG. 12 are illustrated in Table 32 below.

TABLE 32

| | | | |
|---|---|---|---|
| Classification of | smarphone | monitor | Keyboard/mouse/ |
| device for each | | | speaker |
| required technique | | | |
| Classification of | WD (dockee) | WDC | Peripheral |
| docking device | | (docking | |
| | | center) | |
| Classification of | WSB host | WSB hub | WSB Peripheral |
| WSB (Wi-Fi Serial | | | |
| Bus) device | | | |
| Classification of Wi- | Display device | Display Sink | X |
| Fi Display Source | | | |

FIG. 12 illustrates a situation in which after a smartphone (dockee) is paired with a monitor (docking center), a function of the smartphone is used by using a keyboard or a mouse (peripheral).

That is, when the dockee accesses the vicinity of the docking environment, the dockee may perform docking with devices within the docking environment.

After docking, the user may use input/output peripherals to interwork with a dockee application. For example, the user may view a screen of the smartphone through the monitor, perform input of the smartphone through the keyboard, listen to a voice of the smartphone through the speaker, and control a screen shift of the smartphone through the mouse.

FIG. 12 is a view illustrating an example in which a wireless docking system using Wi-Fi proposed in the present disclosure is utilized in a house or an office.

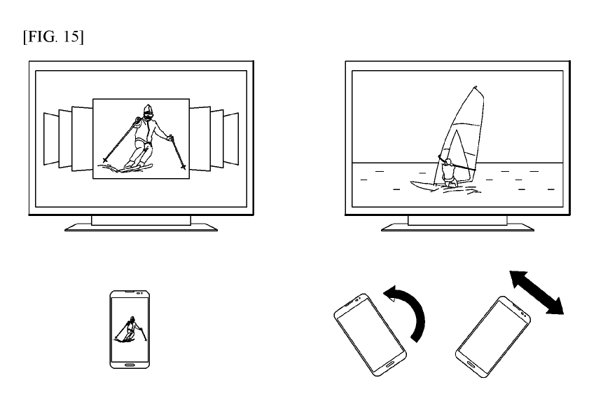

FIG. 13 is a view illustrating an example in which a wireless docking system using Wi-Fi proposed in the present disclosure is utilized in a public place.

Here, the public place may be a hotel, an Internet café, a bank, an airplane, or a train.

FIG. 13 illustrates a situation in which one dockee (WD) selects one of a plurality of docking centers (WDCs) and performs a docking service.

As illustrated in FIG. 13, when the dockee (for example, a smartphone) enters a hotspot zone, the dockee performs wireless docking with one of the plurality of docking centers.

Here, wireless docking may be performed as the dockee is placed on a wireless charging pad.

Thereafter, (enhanced) input/output peripherals may be controlled to utilize dockee applications. For example, the user may output specific document files within the dockee by controlling the printer.

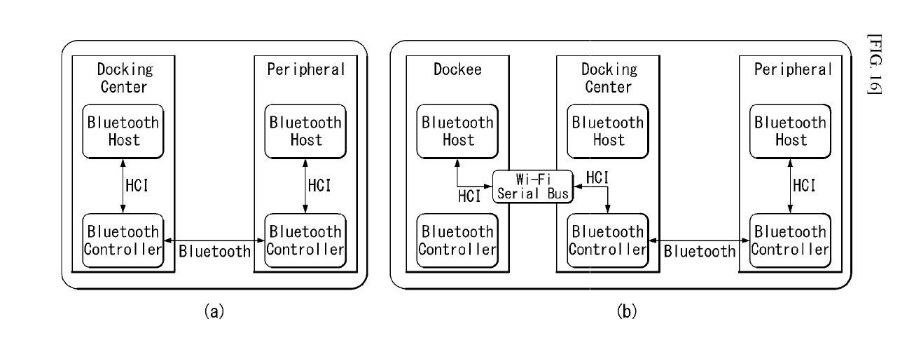

FIG. 14 is a view illustrating another example in which a wireless docking system using Wi-Fi proposed in the present disclosure is utilized.

FIG. 14 illustrates a situation in which one of a plurality of dockees preoccupies one docking center.

Descriptions and functions of components constituting the wireless docking system of FIG. 14 are as illustrated in Table 33 below.

TABLE 33

| | | | |
|---|---|---|---|
| Classification of | Smartphone | monitor | keyboard/mouse/ |
| devices for required | | | speaker |
| techniques | | | |
| Classification of | WD (dockee) | WDC | Peripheral |
| Docking devices | | (docking | |
| | | center) | |
| Classification of | WSB host | WSB hub | WSB Peripheral |
| WSB (Wi-Fi Serial | | | |
| Bus) device | | | |
| Classification of Wi- | Display Source | Display Sink | X |
| Fi Display device | | | |

As illustrated in FIG. 14, a plurality of dockees may be present in a meeting room. In this case, only one of the plurality of dockees preoccupies the docking center.

Thereafter, when the use of docking by the dockee which has preoccupied the docking center is terminated, authority to occupy the docking center is switched to another dockee.

For example, a process of switching authority to occupy the docking center to another dockee may be as follows.

When the docking center receives information indicating that the use of docking by the dockee has terminated, from the dockee which has preoccupied the docking center, the docking center may transmit information indicating that the use of the docking center by the dockee which has preoccupied the docking center has terminated and that the docking center is available for docking connection to other dockees in a broadcast or unicast manner.

In a case in which order of a next dockee to be paired with the docking center when the use of docking by the dockee which has preoccupied the docking center terminates has been determined, the docking center may automatically perform pairing with the next dockee.

If a next dockee to be paired with the docking center has not been determined, the docking center may switch authority to occupy the docking center to other dockee in consideration of reception signal strength of a dockee, capacity of a dockee, a distance to a dockee/position of a dockee, and a request order of a dockee to the docking center.

FIG. 15 is a view illustrating a situation in which a dockee directly controls a docking center without using a peripheral in a wireless docking system using Wi-Fi proposed in the present disclosure.

In this case, the dockee needs to have a function of a peripheral, as well as a function of the dockee.

That is, in a case in which both the dockee function and the peripheral function are activated in the dockee, the dockee may directly use the docking service without using a peripheral.

For example, a screen of the dockee may be output to the docking center and the screen output on the docking center may be controlled by using a movement of the dockee.

Indication whether the dockee performs multiple functions may be included in information in a message transmitted and received between the dockee and the docking center.

Bluetooth HCU Tunneling

Hereinafter, a method for tunneling a peripheral device with a dockee using a docking center when an interface between the peripheral device and the docking center performs a Bluetooth communication will be specifically considered.

As described above, Wi-Fi docking is divided into a dockee, a docking center, and a peripheral device according to the role of each device.

The peripheral device is generally connected to a docking center with a sufficient hardware (H/W) resource.

The tunneling encapsulates the packet of a lower layer communication protocol with an upper layer communication protocol and refers to enabling communication between two points on the communication network.

In order to perform a tunneling between a dockee and a peripheral device proposed in the present specification, the following 3 methods may be defined.

1. A method of tunneling Bluetooth HCI information between a dockee and a docking center

2. A synchronization procedure between a Bluetooth host of a dockee and a Bluetooth controller of a docking center

3. A Bluetooth HCI tunneling method by a service (profile) discovery and a service matching

First, a method of tunneling Bluetooth HCI information between a dockee and a docking center will be described with reference to FIG. 16.

Here, tunneling Bluetooth HCI information may be understood as exchanging by encapsulating Bluetooth HCI information.

FIG. 16 illustrates an example of a method of tunneling Bluetooth HCI information between a dockee and a docking center which are proposed in the present specification.

Specifically, FIG. 16a schematically illustrates a method of communication using Bluetooth technology between a docking center and a peripheral device and FIG. 16b schematically illustrates a method of tunneling Bluetooth HCI information between a docket and a docking center proposed in the present specification.

Generally, a dockee existing in a docking system may be a small device such as a mobile phone.

Most of peripheral devices are frequently connected to a docking center through a USB, and thus a dockee and peripheral devices may be indirectly connected using a Wi-Fi serial bus (WSB) communication technology which wirelessly transmits a USB interface.

However, the methods proposed in the present specification to be considered below are examples of cases that the docking center and the peripheral device are connected through Bluetooth communication.

As illustrated in FIG. 16, a Bluetooth device, i.e., dockee/docking center/peripheral device, is physically divided into a Bluetooth host part on which a software area is mounted, and a Bluetooth controller which is a chipset area (or hardware area) such as MAC layer/PHY layer.

Here, the physical and/or logical communication form of a Bluetooth host and a Bluetooth controller are divided by a host controller interface (HCI).

As illustrated in FIG. 16b, a dockee exchanges or tunnels Bluetooth HCI information using Wi-Fi serial bus between the Bluetooth host of the dockee and the Bluetooth controller of the docking center in order to recognize the Bluetooth peripheral device which is not directly connected to the dockee.

The peripheral device has been connected to the docking center through Bluetooth communication.

The dockee is connected to the docking center through wireless communication such as Bluetooth and Wi-Fi and desires to use a Bluetooth device connected to the docking center, i.e., a peripheral device, the dockee and the docking center logically block HCI connection between the Bluetooth host of the dockee and the Bluetooth controller.

Thereafter, the dockee completes Wi-Fi serious bus (WSB) connection by mutual connection through the docking center and W-Fi.

Thereafter, the docking center encapsulates HCI information of the Bluetooth controller of the docking center according to the WSB and then transmits or tunnels the encapsulated HCI information through the connected WSB.

The dockee receives Bluetooth controller HCI information of the docking center which has been encapsulated with the WSB and is connected to the Bluetooth host of the dockee.

Through the above-considered procedure, the Bluetooth host of the dockee is logically connected to the Bluetooth controller of the docking center, and thus the dockee may be recognized as being connected to the peripheral device connected to the docking center and may use the peripheral device.

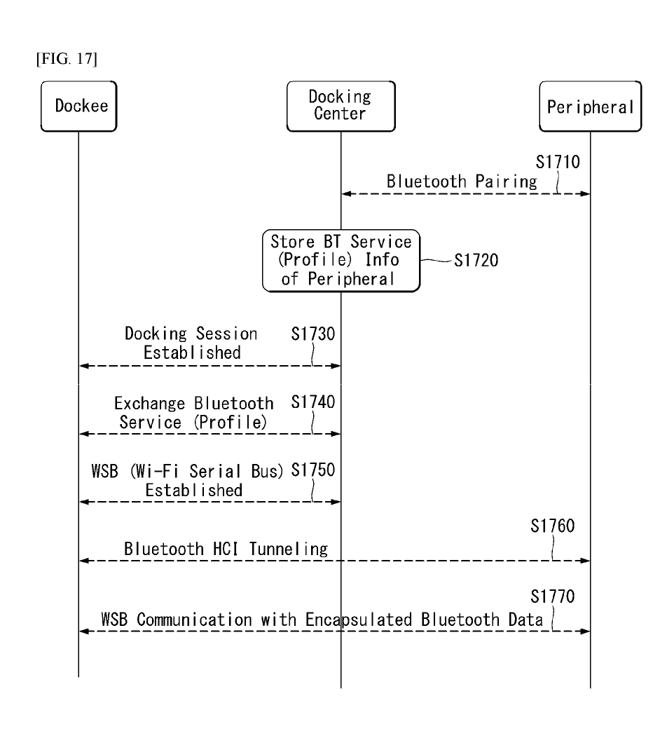

Hereinafter, a synchronization procedure of a Bluetooth controller and a Bluetooth host between a dockee and a docking center will be described in detail with reference to FIG. 17.

FIG. 17 is a flowchart illustrating an example of a synchronization procedure between a dockee and a docking center which are proposed in the present specification.

As illustrated in FIG. 17, before the docking connection between the dockee and the docking center, the docking center and the peripheral device are already Bluetooth-paired through Bluetooth communication (S1710).

Thereafter, the docking center stores service information of the peripheral device obtained through the Bluetooth pairing procedure with the peripheral device (S1720).

Thereafter, the dockee performs a docking connection with the docking center using Wi-Fi (serial bus) (S1730).

Here, the performance of the docking connection may be understood as establishing a docking session.

Thereafter, the docking center transmits service information of the peripheral device stored in step S1720 to the dockee (S1740).

Here, the step S1740 may be omitted if necessary.

Namely, service information of the peripheral device indicates Bluetooth profile information provided by the peripheral device and the transmission procedure of the service information may be omitted if unnecessary.

Thereafter, the dockee completes the WSB connection procedure with the docking center using the WSB in order to provided Bluetooth controller HCI information of the docking center through Wi-Fi (S1750).

Thereafter, the docking center transmits Bluetooth controller HCI information of the docking center to the Bluetooth host of the dockee through WSB communication.

Here, HCI information means Bluetooth HCI information encapsulated through WSB.

As such, a Bluetooth HCI tunneling is formed between the dockee and the peripheral device (S1760).

Thereafter, WSB communication is performed between the dockee and the peripheral device with Bluetooth data encapsulated through the formed tunneling (S1770).

Namely, as illustrated in FIG. 17, the method of performing a Bluetooth HCI tunneling using WSB means a form of logically connecting the Bluetooth host of the dockee with the Bluetooth controller of the docking center, and in this case, bi-direction communication is supported.

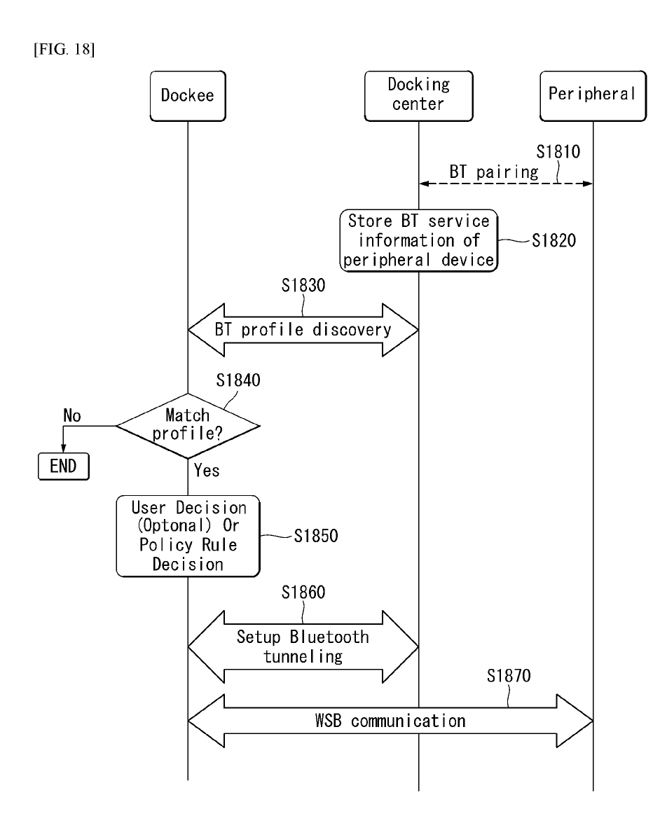

Hereinafter, a method of tunneling Bluetooth HCI by a service (profile) discovery procedure between a dockee and a docking center and a service (profile) matching procedure in the dockee will be described with reference to FIG. 18.

FIG. 18 is a flowchart illustrating an example of a Bluetooth HCU tunneling method proposed in the present specification.

Specifically, FIG. 18 shows a method of performing a service (or profile) discovery procedure between a dockee and a docking center and providing whether a Bluetooth (HCI) tunneling function is to be used through a service matching procedure.

S1810 and S1820 are the same as S1710 and S1720 of FIG. 17, and thus the specific description thereof will be omitted.

After step S1820, the dockee performs a docking connection with the docking center.

The specific procedure of the docking connection has already been explained above.

Thereafter, the dockee performs a Bluetooth profile discovery procedure with the docking center (S1830).

Specifically, the Bluetooth profile discovery procedure refers to a procedure of discovering, by a dockee, a service such as a profile provided by the peripheral device when there is a Bluetooth discovery procedure dependent on the docking center.

The dockee may determine whether the profile of the Bluetooth host of the dockee coincides with the profile of the discovered peripheral device through the docking center and the Bluetooth profile discovery procedure.

Here, the number of profiles of each of the dockee and the peripheral device may be plural.

For example, the profiles provided by the Bluetooth host of the dockee are A, B and C, and the profiles provided by the discovered peripheral device (or the Bluetooth controller of the docking center) may be B, C and D.

In this case, the function of the peripheral device usable by the dockee may be a mutually matched profile, i.e., common parts B and C.

Namely, the dockee means using Bluetooth profiles B and C of the peripheral device.

Thereafter, the dockee performs a profile matching procedure (S1840).

When there is a profile matched through the profile matching procedure, the dockee may determine whether to use the Bluetooth peripheral device according to the user's decision or a certain policy (or criterion) (S1850).

Examples of the certain policy are as follows.

As a result of a profile matching, if there are one or more matched profiles, the dockee attempts a Bluetooth HCI tunneling with the docking center.

As a result of a profile matching, only when all profiles of the dockee are included in the discovered peripheral device, the dockee attempts a Bluetooth tunneling with the docking center.

A profile matching result is provided to the user or output unit, and the dockee attempts Bluetooth HCI tunneling with the docking center depending on the user's decision.

The certain policy may be summarized as Equations 1 and 2 below.

If(U_{Dockee} ∩ U_{Discoiscov} ≠ Ø), do Tunneling [Equation 1]

If(U_{Dockee} ⊂ U_{Discoiscov}), do Tunneling [Equation 2]

As a result of the profile matching, if there is no matched profile, the dockee abandons the use off the Bluetooth peripheral device.

Namely, if there is a matched profile through the profile matching procedure, the dockee performs a Bluetooth tunneling setup process with the docking center (S1860).

Thereafter, the dockee transmits and receives Bluetooth data through WSB communication with the peripheral device (which is Bluetooth-paired with the docking center) (S1870).

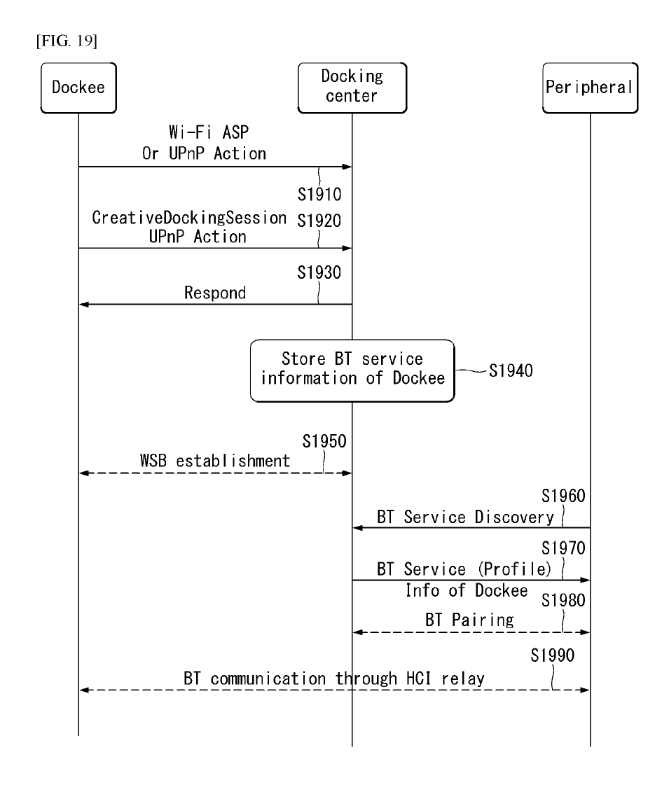

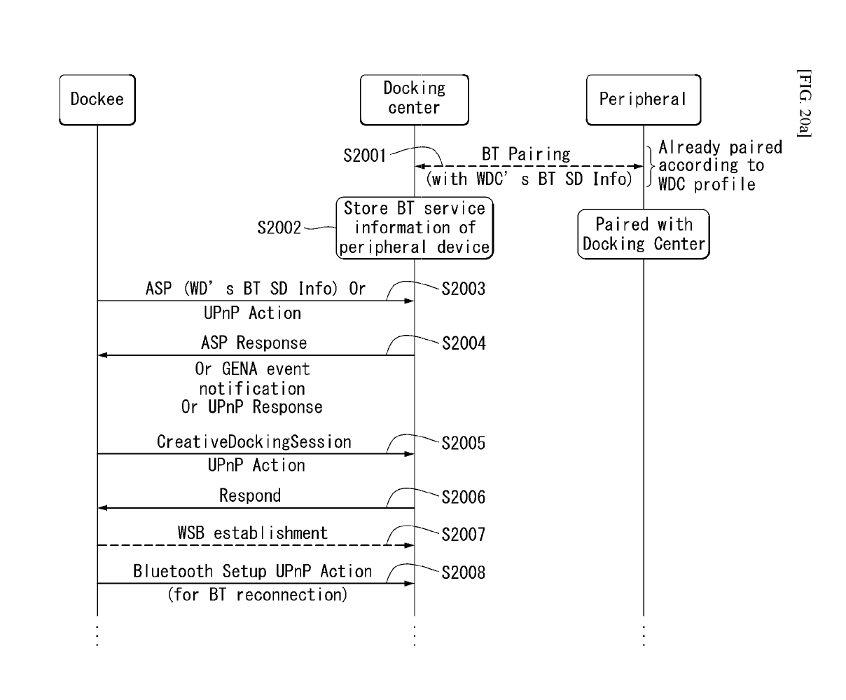

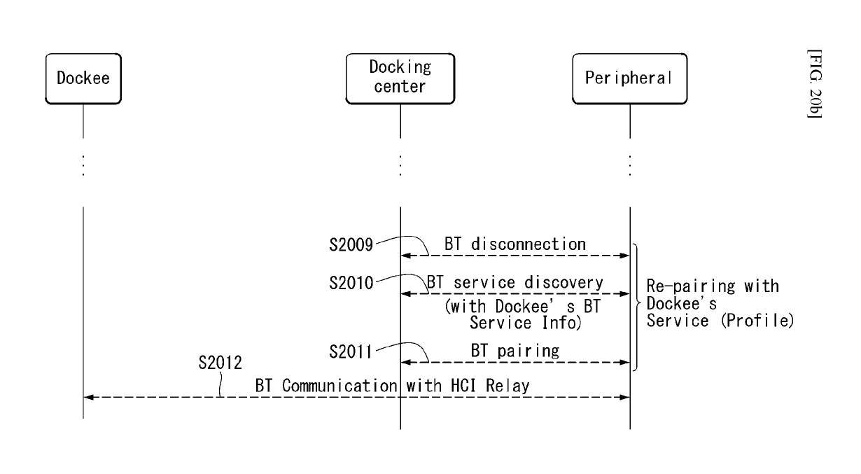

Thereafter, when a Bluetooth paring is performed between a docking center (WDC) and a peripheral device in the state that a dockee (WD) and the docking center (WDC) are connected, a method of using, by a dockee, the peripheral device will be described in detail with reference to FIG. 19.

FIG. 19 is a flowchart illustrating an example of a method of using a peripheral device through a Bluetooth HCI tunneling proposed in the present specification.

First, the dockee transmits service (profile) information provided in the Bluetooth host of the dockee to the docking center through Wi-Fi ASP (application service platform) (S1910).

Here, the Wi-Fi ASP operation may be substituted with UPnP (universal plug & play) action (as necessary).

When substituted as the UPnP action, the dockee may transmit CreativeDockingSession UPnP action to the docking center in order to establish a docking session with the docking center (S1920) and then may receive a response to the CreativeDockingSession UPnP action from the docking center (S1930).

Through such a process, the dockee establishes a docking connection or docking session with the docking center.

Thereafter, the docking center stores Bluetooth service (profile) information received from the dockee (S1940).

Thereafter, the dockee establishes WSB connection by performing a WSB connection process with the docking center (S1950).

Thereafter, the peripheral device performs a Bluetooth service discovery procedure in order to perform a Bluetooth service discovery procedure in order to perform a Bluetooth pairing with the docking center (S1960).

Namely, the peripheral device transmits a BT service discovery message to the docking center.

Thereafter, the docking center performs a Bluetooth service discovery procedure with the peripheral device by transmitting Bluetooth service (profile) information of the dockee stored through step S1940, which is not Bluetooth service (profile) information of the docking center, to the peripheral device (S1970).

Thereafter, the peripheral device completes a Bluetooth pairing with the docking center by utilizing Bluetooth service (profile) information which is finally supported by the dockee (S1980) and completes a Bluetooth HCI tunneling with the dockee through WSB encapsulation (S1990).

Here, the Bluetooth HCI tunneling may perform Bluetooth communication through HCI between a Bluetooth host and a Bluetooth controller by encapsulating Bluetooth data.

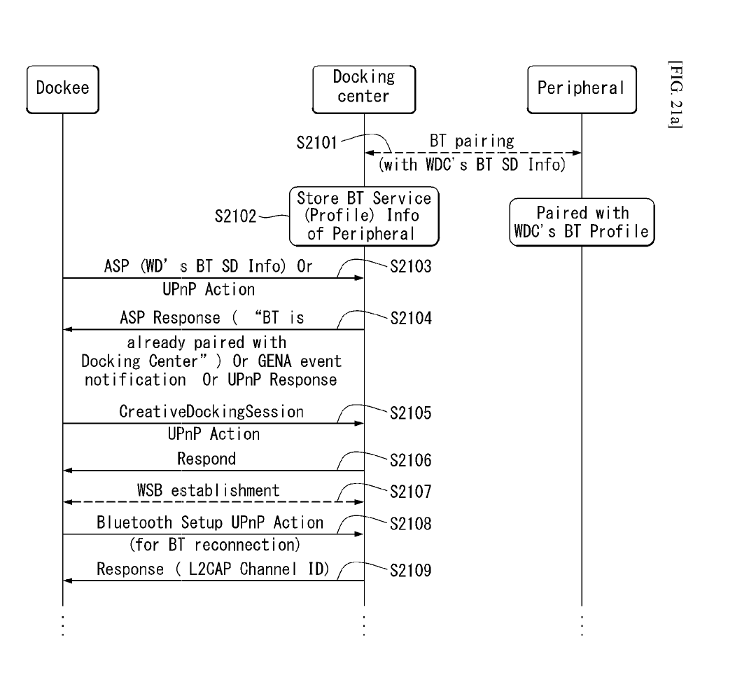

Hereinafter, a method of performing a Bluetooth HCI tunneling by proceeding a docking connection between a dockee (WD) and a docking center in a Bluetooth pairing state between a docking center (WDC) and a peripheral device will be described with reference to FIG. 20.

FIG. 20 is a flowchart illustrating another example of a method of using a peripheral device through a Bluetooth HCI tunneling proposed in the present specification.

Namely, in the case of FIG. 20, the docking center completes a Bluetooth pairing with the peripheral device and then the dockee attempts a docking connection to the docking center.

Thereafter, it shows a method of performing, by the docking center, a Bluetooth pairing with the peripheral device in order to form a new L2CAP channel between the dockee and the peripheral device.

First, the docking center performs a Bluetooth pairing procedure with the peripheral device (S2001).

The Bluetooth pairing procedure of the docking center and the peripheral device is performed according to the Bluetooth service (profile) of the docking center.

The peripheral device transmits the Bluetooth service (profile) information of the peripheral device to the docking center through the Bluetooth pairing procedure.

Thereafter, the docking center stores Bluetooth service (profile) information of the peripheral device obtained through step S2001 (S2002).

Thereafter, the dockee performs a docking connection with the docking center.

With respect to the docking connection, the dockee requests Bluetooth service (profile) information of the peripheral device which has been Bluetooth-paired with the docking center in step S2001 through Wi-Fi ASP or UPnP to the docking center (S2003).

The Wi-Fi ASP or UPnP action may include BT SD (service discovery) information of the dockee.

The BT SD information of the dockee may mean the Bluetooth service (profile) of the dockee.

Thereafter, the docking center transmits Bluetooth service information of the already stored peripheral device to the dockee (S2004).

The Bluetooth service information of the already stored peripheral device may be transmitted through Wi-Fi ASP response message or GENA (general event notification architecture) event notification message or UPnP response message.

Thereafter, as explained in steps S1920, S1930, and S1950 of FIG. 19, a docking session establishment procedure and a WSB (Wi-Fi serial bus) establishment procedure are performed between the dockee and the docking center (S2005 to S2007).

As such, Bluetooth HCI information may be tunneled between the dockee and the peripheral device.

However, in the case of FIG. 20, the Bluetooth pairing between the docking center and the peripheral device is in the state that logical session in the transport layer step has already been completed by Bluetooth L2CAP (logical link control and adaptation protocol) existing in the Bluetooth host of the docking center and the Bluetooth host of the peripheral device.

Hence, the peripheral device should form a new connection with L2CAP within the Bluetooth host of the dockee after step S2007.

Hence, in order to form a new L2CAP connection between the dockee and the peripheral device or perform a L2CAP reconnection procedure, the docking center performs reconnection of the peripheral device and the Bluetooth pairing itself.

To this end, the dockee transmits Bluetooth setup UPnP action requesting Bluetooth pairing reconnection to the docking center (S2008).

The Bluetooth setup UPnP action may include information indicating Bluetooth pairing reconnection between the docking center and the peripheral device.

Thereafter, the docking center and the peripheral device perform a Bluetooth repairing procedure based on Bluetooth service information, etc. of the dockee.

Specifically, the Bluetooth repairing procedure is as follows. (1) Bluetooth connection between the docking center and the peripheral device is canceled (S2009), (2) The BT service discovery procedure is performed based on the BT service information of the dockee (S2010), and the BT pairing procedure is performed (S2011).

Further, when the dockee is undocked from the docking center, the docking center and the peripheral device may perform the Bluetooth pairing procedure again.

Thereafter, the dockee and the peripheral device perform BT communication through a Bluetooth HCI tunneling or a HCI relay through WSB encapsulation (S2012).

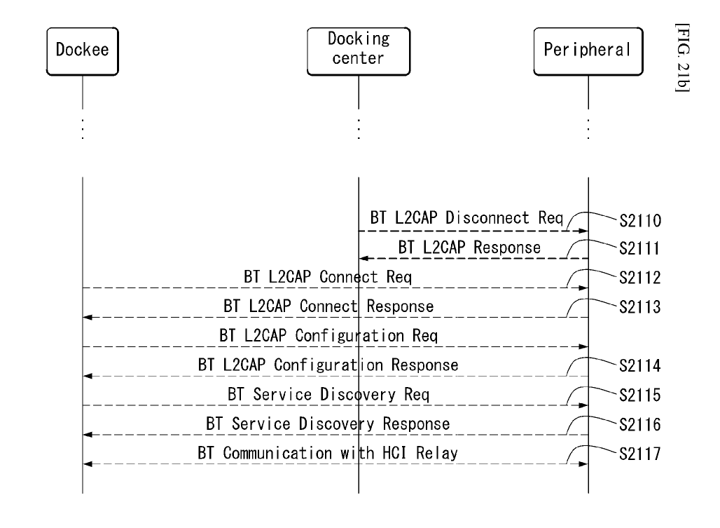

Hereinafter, another method of performing a docking connection between a dockee and a docking center in the Bluetooth pairing state between the docking center and the peripheral device will be described with reference to FIG. 21.

FIG. 21 is a flowchart illustrating another example of a method of using a peripheral device through a Bluetooth HCI tunneling proposed in the present specification.

Namely, FIG. 21 shows a method of completing a Bluetooth pairing between the docking center and the peripheral device, then attempting, by the dockee, a docking connection to the docking center, and forming a new L2CAP connection between the dockee and the peripheral device while maintaining L2CAP connection between the docking center and the peripheral device.

Steps S2101 to S2107 are the same as steps S2001 to S2007 of FIG. 20 and have already been described with reference to FIG. 20, and here the description centers on points different from FIG. 20.

As explained with reference to FIG. 20, the Bluetooth pairing of the docking center and the peripheral device have already completed the logical session of the transport layer step according to Bluetooth L2CAP (logical link control and adaptation protocol) existing in the Bluetooth host of the Bluetooth host and the docking center of the peripheral device.

Hence, the peripheral device should form a new connection with L2CAP within the Bluetooth host of a new dockee.

Namely, FIG. 21 shows a method of resetting only L2CAP channel between the dockee and the peripheral device while maintaining the Bluetooth pairing between the docking center and the peripheral device.

After step S2107, the dockee transmits Bluetooth step UPnP action for BT reconnection with the peripheral device to the docking center and the setting of a new Bluetooth L2CAP channel (S2108).

Thereafter, the docking center transmits a response including L2CAP channel ID stored in the Bluetooth host of the docking center, i.e., the response to the Bluetooth setup UPnP action, to the dockee through the Bluetooth pairing in step S2101 (S2109).

Thereafter, the docking center performs BT L2CAP disconnection procedure with the peripheral device in order to terminate L2CAP channel of the docking center itself and the peripheral device (S2110).

Thereafter, peripheral device performs a procedure of newly setting a Bluetooth L2CAP channel with the dockee or resetting L2CAP connection while maintaining a Bluetooth pairing with the already formed docking center.

Namely, the dockee transmits a BT L2CAP connect request to the peripheral device through WSB (Wi-Fi serial bus) (S2111), and the docking center transmits the BT L2CAP connect response to the dockee in response to the BT L2CAP connect request (S2112).

Thereafter, the dockee and the peripheral device perform the BT L2CAP configuration procedure (S2113 and S2114).

Namely, the dockee transmits BT L2CAP configuration request message to the peripheral device (S2113) and receives BT L2CAP configuration response message from the peripheral device in response thereto (S2114).

As such, the dockee and the peripheral device set a new L2CAP connection within each Bluetooth host and then additionally perform a BT service discovery procedure through WSB in order to profile-match the Bluetooth profile which needs the dockee with the peripheral device.

In the case of the BT service discovery procedure, the dockee transmits the BT service discovery request message to the peripheral device (S2115) and receives the BT service discovery response message from the peripheral device in response thereto (S2116).

Here, the Bluetooth device of the dockee plays the client role of the BT service discovery, and the peripheral device plays the server role of the BT service discovery.

Thereafter, the dockee and the peripheral device performs BT communication through the Bluetooth HCI tunneling or HCI relay through WSB encapsulation (S2117).

Further, when the dockee is undocked from the docking center or the peripheral device, Bluetooth L2CAP channel of the peripheral device should be connected to the docking center again, and thus the Bluetooth L2CAP disconnection procedure for reversely performing the above-described Bluetooth L2CAP reconnection may be performed.

An example of XML form of Bluetooth information exchanged in Bluetooth setup UPnP action or Bluetooth service (profile) discovery procedure which has been explained with reference to FIGS. 19 to 21 may be as follows.

```
<xsd:simpleType name=“PeripheralFunctionProtocolNameType”>
        <xs:union memberTypes=“PfpNameEnumType PfpNameAnyStringType”/>
    </xs:simpleType>
    <xs:simpleType name=“PfpNameEnumType”>
        <xsd:restriction base=“xsd:string”>
            <xsd:enumeration value=“wifiDisplay”/>
            <xsd:enumeration value=“wifiSerialBus”/>
            <xsd:enumeration value=“wfdsPrint”/>
            <xsd:enumeration value=“wfdsDisplay”/>
            <xsd:enumeration value=“wfdsSend”/>
            <xsd:enumeration value=“wfdsPlay”/>
            <xsd:enumeration value=“wde”/>
            <xsd:enumeration value=“wbe”/>
            <xsd:enumeration value=“wsd”/>
            <xsd:enumeration value=“dlna”/>
            <xsd:enumeration value=“upnp”/>
            <xsd:enumeration value=“bluetooth”/
        </xsd:restriction>
<xsd:complexType name=“PfpSimpleInfoType”>
        <xsd:sequence>
            <xsd:element name=“name” type=“tns:PeripheralFunctionProtocolNameType”/>
            <xsd:element name=“ver” type=“xsd:string”/>
            <xsd:element name=“connectionType” type=“xsd:PfpConnectionType”/>
            <xsd:element name=“operatingFrequency” type=“tns:OperatingFrequencyType”
minOccurs=“0“ maxOccurs=“unbounded”/> </xsd:sequence>
    </xsd:complexType>
<xsd:complexType name=“PfpDetailedInfoType”>
        <xsd:sequence>
            <xsd:element name=“name” type=“tns:PeripheralFunctionProtocolNameType”/>
            <xsd:element name=“ver” type=“xsd:string”/>
            <xsd:element name=“connectionType” type=“xsd:PfpConnectionType”/>
            <xsd:element name=“operatingFrequency” type=“tns:OperatingFrequencyType”
minOccurs=“0” maxOccurs=“unbounded”/>
            <xsd:element name=“discoveryInfo” type=“xsd:PfpServiceDiscoveryInfoType”/>
        </xsd:sequence>
            </xsd:complexType>
```

Further, Bluetooth-related information exchanged in the Bluetooth service (profile) discovery procedure may include Service Class ID List, Protocol Descriptor List, LanguageBaseAttributeIDList, ServiceName, ServiceDescription, ProviderName, VendorID, ProductID, Version, PrimaryRecord, VendorIDSource and the like.

An example of the Bluetooth-related information may be as Table 34 below.

TABLE 34

| values | Description |
|---|---|
| 0x0001 | ServiceClassIDList |
| 0x0004 | ProtocolDescriptorList |
| 0x0009 | BluetoothProfileDescriptorList |
| 0x0006 | LanguageBaseAttributeIDList |
| 0xLL00 | ServiceName |
| 0xLL01 | ServiceDescription |
| 0xLL02 | ProviderName |
| 0x0201 | VendorID |
| 0x0202 | ProductID |
| 0x0203 | Version |
| 0x0204 | PrimaryRecord |
| 0x0205 | VendorIDSource |

Further, each drawing has been separately described for the convenience of description, but it is possible to combine embodiments described in each drawing so as to implement a new embodiment. Further, designing a computer-readable recording medium readable having recorded thereon a program for executing the above-described embodiments belongs to the scope of rights of the present invention.

The Bluetooth HCI tunneling method according to the present specification is not limited to the configuration and method of the above-described embodiments, but the whole or part of respective embodiments may be selectively combined for various modifications of the embodiments.

Meanwhile, the Bluetooth HCI tunneling method of the present specification may be implemented as processor-readable codes in a processor-readable recording medium included in a network device. The processor-readable recording medium includes all kinds of recording devices where data is saved. The processor-readable recording medium includes a ROM, a RAM, a CD-ROM, a magnetic tape, a floppy disk drive, an optical data storage device and the like and includes what is implemented in the form of a carrier wave such as transmission through Internet. Further, a processor-readable recording medium may be distributed to a computer system connected by a network, and processor-readable codes may be stored and executed in a distributed manner.

Further, desirable embodiments of the present specification have been described above, but the present specification is not limited to a specific embodiment. Rather, various modifications of the embodiments are possible by one of ordinary skill in the art to which the present invention belongs without going beyond the gist of the present invention claimed in the claims, and such modified embodiments should not be construed as being separate from the technical concept of the present invention.

Further, the present specification describes both an object invention and a method invention, and the description on both inventions may be applied in a supplementary manner as necessary.

### INDUSTRIAL APPLICABILITY

The present specification relates to a docking system, and more particularly, to using a wireless docking service in a home network environment.

1. A method for performing, by a wireless dockee center (WDC), a docking service in a docking system, the method comprising:
performing a docking connection procedure with a wireless dockee (WD);
establishing a WSB (Wi-Fi Serial Bus) connection with the wireless dockee; and
communicating with a Bluetooth host of the wireless dockee using a host controller interface (HCI),
wherein the Bluetooth host of the wireless dockee is connected to a Bluetooth controller of the wireless dockee center through the HCI.

2. The method of claim 1, further comprising:
blocking HCI of, the Bluetooth controller and a Bluetooth host of the wireless dockee center, for Bluetooth HCI connection with the Bluetooth host of the wireless dockee; and
transmitting HCI information of the Bluetooth controller of the wireless dockee center to the wireless dockee.

3. The method of claim 1, further comprising:
performing a Bluetooth pairing procedure with a peripheral device; and
storing Bluetooth service information of the peripheral device obtained through the Bluetooth pairing procedure.

4. The method of claim 3, further comprising performing a Bluetooth service discovery procedure with the wireless dockee.

5. The method of claim 4,
wherein the Bluetooth service discovery procedure comprises transmitting the stored Bluetooth service information of the peripheral device to the wireless dockee.

6. The method of claim 5,
wherein the stored Bluetooth service information of the peripheral device is transmitted through a Wi-Fi ASP (application service platform) response message, a GENA (general event notification architecture) event notification message or a UPnP (universal plug & play) response message.

7. The method of claim 1,
wherein the performing of the docking connection comprises:
receiving a service information provided from the Bluetooth host of the wireless dockee from the wireless dockee; and
storing the received service information provided from the Bluetooth host of the wireless dockee.

8. The method of claim 7,
wherein the service information provided from the Bluetooth host of the wireless dockee is received from the wireless dockee through Wi-Fi ASP or UPnP action.

9. The method of claim 3, further comprising:
performing a Bluetooth service discovery procedure with the peripheral device; and
performing a Bluetooth pairing procedure with the peripheral device.

10. The method of claim 9,
wherein the Bluetooth service discovery procedure comprises:
receiving a Bluetooth service discovery message from the peripheral device; and
transmitting the stored Bluetooth service information of the wireless dockee to the peripheral device.

11. The method of claim 3, further comprising:
setting a new Bluetooth L2CAP (logical link control and adaptation) between the wireless dockee and the peripheral device after establishing the WSB connection.

12. The method of claim 11,
wherein the setting of the new L2CAP channel comprises:
receiving from the wireless dockee, a control message requesting a reattempt of the Bluetooth pairing procedure between the wireless dockee center and the peripheral device.

13. The method of claim 12,
wherein the setting of the new Bluetooth L2CAP channel further comprises:
transmitting a response to the control message to the wireless dockee,
wherein the response comprises a Bluetooth L2CAP channel ID (identifier) which has already been formed with the peripheral device.

14. The method of claim 13, further comprising:
Performing a disconnection of the Bluetooth L2CAP channel which has already been formed with the peripheral device.

15. The method of claim 12, wherein the control message is a Bluetooth setup UPnP action.

16. A method for performing, by a wireless dockee (WD), a docking service in a docking system, the method comprising:
performing a docking connection procedure with a wireless dockee center (WDC);
establishing a WSB (Wi-Fi serial bus) connection with the wireless dockee center; and
communicating with a Bluetooth controller of the wireless dockee center using a host controller interface (HCI),
wherein the Bluetooth controller of the wireless dockee center is connected to a Bluetooth host of the wireless dockee through the HCI.

17. The method of claim 16, further comprising:
receiving HCI (host controller interface) information of the Bluetooth controller of the wireless dockee center, from the wireless dockee center; and
performing a Bluetooth service discovery procedure with the wireless dockee center,
wherein the Bluetooth service discovery procedure further comprises:
receiving Bluetooth service information of a peripheral device, which is stored in the wireless dockee center, from the wireless dockee center;
matching a service of the Bluetooth host of the wireless dockee with the received service of the peripheral device; and
determining whether to use the peripheral device according to a certain criterion as a result of the matching.

18. The method of claim 17,
wherein the certain criterion is a case that there is at least one matched service, a case that the service of the wireless dockee is entirely included in the service of the peripheral device, or a case that there is no matched service.

19. The method of claim 18,
wherein as a result of the matching, if there is the at least one matched service or the service of the wireless dockee is entirely included in the service of the peripheral device, a Bluetooth HCI tunneling is performed with the peripheral device.

20. A wireless dockee (WD) apparatus for performing a docking service in a docking system, the wireless dockee apparatus comprising:
a communication unit for communicating with an external side in a wireless or wired manner; and
a controller functionally connected to the communication unit,
wherein the controller is configured to:
perform a docking connection procedure with a wireless dockee center (WDC);
establish a WSB (Wi-Fi serial bus) connection with the wireless dockee center; and
communicate with a Bluetooth controller of the wireless dockee center using a HCI (host controller interface),
wherein the Bluetooth controller of the wireless dockee center is connected to a Bluetooth host of the wireless dockee through the HCI.
